(19) United States
(12) Patent Application Publication
(10) Pub. No.: US 2016/0154930 A1
(43) Pub. Date: Jun. 2, 2016

(54) METHODS FOR IDENTIFICATION OF INDIVIDUALS

(71) Applicant: THE UNIVERSITY OF NORTH CAROLINA AT CHAPEL HILL, Chapel Hill, NC (US)

(72) Inventors: Jason Lieb, Princeton, NJ (US); Jeremy Simon, Carrboro, NC (US); William Jeck, Chapel Hill, NC (US)

(21) Appl. No.: 14/904,236

(22) PCT Filed: Jul. 11, 2014
(86) PCT No.: PCT/US2014/046309

§ 371 Date: Jan. 11, 2016

Related U.S. Application Data
(60) Provisional application No. 61/845,397, filed on Jul. 12, 2013.

(51) Int. Cl. G06F 19/22; G06F 19/00

(52) U.S. Cl. CPC G06F 19/22; G06F 19/322

(57) ABSTRACT

Methods of identifying individuals are presented.

### STATEMENT OF PRIORITY

This application claims the benefit of U.S. Provisional Application Ser. No. 61/845,397, filed Jul. 12, 2013, the entire contents of which are incorporated by reference herein.

### FIELD OF THE INVENTION

The present invention relates to methods for identifying individuals based on the comparison of nucleic acid sequence data to reference sequence(s).

### BACKGROUND OF THE INVENTION

The identification of individuals through biometrics, such as fingerprint, iris, retinal or facial recognition, has found numerous widespread uses, including law enforcement, security, and forensics. These methods have been applied widely over the past several decades for rapid identification of individuals. However, those methods have limited sensitivity and specificity in identification. Fingerprint identification, for example, has sensitivity and specificity values of approximately 96% and 80% (see, e.g., Kafadara, Technical Report 11-01, Department of Statistics, Indiana University, 2011 (www.stat.indiana.edu/files/TR/TR-11-01.pdf)), making it inapplicable to high volume screening situations. Iris scanning, though an order of magnitude better with sensitivity and specificity of 99.5% under ideal conditions (see, e.g., Miyazawa, IEEE Trans Pattern Anal Mach Intell. 2008 October; 30(10)1741-56 2008), may likewise be insufficiently powered to deal with high volume testing. Furthermore, those methods do not provide information about the relatedness of a given individual to another, the relatedness of an individual to another group of individuals, or information regarding the potential geographic or ethnic origin of an individual.

Biometric methods for identification also include the use of DNA sequences. Those methods commonly include a set of “short tandem repeat” (STR) sequences, regions that vary in length between individuals and are relatively few in number. Current methods implementing these STR-based DNA biometrics (e.g., EP 1967593 A3, WO 1996010648 A2, EP 2055787 A1) require long wail times and high-quality DNA samples (see, e.g., Kayser, Nat Rev Genet. 2011 March; 12(3):179-92, 2011). STR typing offers limited specificity, utilizes matching to a fixed database or reference sample, and provides little additional information about the individual other than identity itself.

High-throughput next-generation sequencing methods, such as those described in Mardis, E. R., Annual Review of Genomics and Human Genetics, 9, pp. 387-402 2008; Liu, L. et at., Journal of Biomedicine & Biotechnology, 2012, Article ID 251364; and Quail et at., BMC Genomics 2012, 13:341 2012; can greatly reduce the time required to collect sufficient sequence data to identify an individual. However, those methods often possess a high error rate, making identification using single nucleotide polymorphisms (SNPs), more difficult (see, e.g., Liu et al.).

There is a need for more effective and rapid identification of individuals for forensics and security. The need for more effective identification additionally includes a need for a robust system that can be used in the field by non-experts, and can rapidly identify a person without requiring the person to spend a long period of time in detention.

Embodiments of the present invention may solve one or more of the above-mentioned problems. Other features and/or advantages, which may solve additional problems, may become apparent from the description that follows.

### SUMMARY OF THE INVENTION

The present disclosure describes nucleic acid based biometrics using high-throughput DNA sequencing coupled to an algorithmic pipeline. The methods described can be applied to sequencing data of a broad range of quality levels, offers information about relatedness to other individuals in a population, including the ethnic or geographic origin of the sample, and provides extremely high confidence of individual identification. Those features enable its application to high-throughput environments where high specificity and sensitivity of identification is desired, as well as to forensic applications where DNA sample quality may be compromised. The methods described are agnostic to sequencing method, and can therefore be applied to current and future DNA sequencing platforms.

The present application provides methods for matching biological samples using nucleic acid sequence data. In certain embodiments, methods of identifying biological samples are provided. In certain embodiments, methods of identifying a best match to a biological sample are provided.

According to certain embodiments, methods of identifying a biological sample are provided. In certain such embodiments, a method of identifying a biological sample comprises: comparing nucleic acid sequence data from a query sequence with nucleic acid sequence data from at least one reference sequence by comparing insertions of 1 base or more and deletions of 1 base or more in the query sequence with insertions of 1 base or more and deletions of 1 base or more in the reference sequence; and determining if the query sequence matches at least one reference sequence by the comparison of insertions of 1 base or more and deletions of 1 base or more, wherein the sequence data from the query sequence has at least a 0.1% error rate. In certain such embodiments, the sequence data from the query sequence has an error rate Rejected from an at least a 0.5% error rate, an at least a 3% error rate, an at least a 5% error rate, an at least a 7% error rate, an at least a 9% error rate, an at least a 10% error rate, an at least a 12% error rate, an at least a 14% error rate, an at least a 16% error rate, an at least an 18% error rate, or an at least a 20% error rate. In certain embodiments, the sequence data from the reference sequences has at least a 0.1% error rate. In certain embodiments, the at least one reference sequence comprises a reference database of genomic sequences. In certain embodiments, the biological sample is from a source selected from: a human, a plant, an animal, bacteria, a fungus, or a virus. In certain embodiments, the comparing nucleotide sequence data from a query sequence with at least one reference comprises using an alignment tool. In certain embodiments, the nucleic acid sequence data from the query sequence is collected in an amount of time selected from: less than 30 minutes, less than 45 minutes, less than 1 hour, less than 2 hours, than 3 hours, less than 6 hours, less than 12 hours, less than 18 hours, or less than 24 hours. In certain embodiments, the determining if the query sequence matches at least one reference sequence results in an exact match. In certain embodiments, the comparing insertions of 1 base of more and deletions of 1 base or more in the query sequence with insertions of 1 base or more and deletions of 1 base or more in the reference sequence comprises comparing insertions of 2 bases or more and deletions of 2 bases or more in the query sequence with insertions of 2 bases or more and deletions of 2 bases or more in the reference sequence. In certain embodiments, the comparing insertions of 1 base or more and deletions of 1 base or more in the query sequence with insertions of 1 base or more and deletions of 1 base or more in the reference sequence comprises comparing insertions of 3 bases or more and deletions of 3 bases or more in the query sequence with insertions of 3 bases or more and deletions of 3 bases 01 more in the reference sequence.

According to certain embodiments, methods of identifying a best match for a biological sample are provided. In certain embodiments, a method of identifying a best match for a biological sample comprises: comparing nucleic acid sequence data from a query sequence with nucleic acid sequence data from at least one reference sequence by comparing insertions of 1 base or more and deletions of 1 base or more in the query sequence with insertions of 1 base or more and deletions of 1 base or more in the reference sequence; and determining if the query sequence matches at least one reference sequence by the comparison of insertions of 1 base or more and deletions of 1 base or more, wherein the sequence, data from the query sequence has at least a 0.1% error rate. In certain such embodiments, the sequence data from the query sequence has an error rate selected from an at least a 0.5% error rate, an at least a 3% error rate, an at least a 5% error rate, an at least a 7% error rate, un at least a 9% error rate, an at least a 10% error rate, an at least a 12% error rate, an at least a 14% error rate, an at least a 16% error rate, an at least an 18% error rate, or an at least a 20% error rate. In certain embodiments, the sequence data from the reference sequences has at least a 0.1% error rate. In certain embodiments, the at least one reference sequence comprises a reference database of genomic sequences. In certain embodiments, the biological sample is from a source selected from; a human, a plant, an animal, bacteria, a fungus, or a virus. In certain embodiments, the comparing nucleotide sequence data from a query sequence with at least one reference comprises using an alignment tool. In certain embodiments, the nucleic acid sequence data from the query sequence is collected in an amount of time selected from: less than 30 minutes, less than 45 minutes, less than 1 hour, less than 2 hours, than 3 hours, less than 6 hours, less than 12 hours, less than 18 hours, or less than 24 hours. In certain embodiments, the determining if the query sequence matches at least one reference sequence results in an exact match. In certain embodiments, the determining if the query sequence matches at least one reference sequence results in an exact match. In certain embodiments, the comparing insertions of 1 base or more and deletions of 1 base or more in the query sequence with insertions of 1 base or more and deletions of 1 base or more in the reference sequence comprises comparing insertions of 2 bases or more and deletions of 2 bases or more in the query sequence with insertions of 2 bases or more and deletions of 2 bases or more in the reference sequence. In certain embodiments, the comparing insertions of 1 base or more and deletions of 1 base or more in the query sequence with insertions of 1 base or more and deletions of 1 base or more in the reference sequence comprises comparing insertions of 3 bases or mote and deletions of 3 bases or more in the query sequence with insertions of 3 bases or more and deletions of 3 bases or more in the reference sequence. In certain embodiments, the biological sample is assigned to a subpopulation based upon the best match to the biological sample.

According to certain embodiments, methods of identifying a biological sample are provided. In certain embodiments, a method of identifying a biological sample comprises: comparing nucleic acid sequence data from a query sequence with nucleic acid sequence data from at least one reference sequence by comparing insertions of 1 base or more and deletions of 1 base or more in the query sequence with insertions of 1 base or more and deletions of 1 base or more in the reference sequence; and determining if the query sequence matches at least one reference sequence by the comparison of insertions of 1 base or more and deletions of 1 base or more, wherein the nucleotide sequence data from the query sequence is collected in less than 30 minutes. In certain such embodiments, the sequence data from the query sequence has an error rate selected from an at least 0.1% error rate, an at least a 0.5% error rate, an at least a 3% error rate, an at least a 5% error rate, an at least a 7% error rate, an at least a 9% error rate, an at least a 10% error rate, an at least a 12% error rate, an at least a 14% error rate, an at least a 16% error rate, an at least an 18% error rate, or an at least a 20% error rate. In certain embodiments, the sequence data from the reference sequences has at least a 0.1% error rate. In certain embodiments, the at least one reference sequence comprises a reference database of genomic sequences. In certain embodiments, the biological sample is from a source selected from: a human, a plant, an animal, bacteria, a fungus, or a virus. In certain embodiments, the comparing nucleotide sequence data from a query sequence with at least one reference comprises using an alignment tool. In certain embodiments, the nucleic acid sequence data from the query sequence is collected in an amount of time selected from: less than 45 minutes, less than 1 hour, less than 2 hours, than 3 hours, less than 6 hours, less than 12 hours, less than 18 hours, or less than 24 hours. In certain embodiments, the determining if the query sequence matches at least one reference sequence results in an exact match. In certain embodiments, the comparing insertions of 1 base or more and deletions of 1 base or more in the query sequence with insertions of 1 base or more and deletions of 1 base or more in the reference sequence comprises comparing insertions of 2 bases or more and deletions of 2 bases or more in the query sequence with insertions of 2 bases or more and deletions of 2 bases or more in the reference sequence. In certain embodiments, the comparing insertions of 1 base or more and deletions of 1 base or more in the query sequence with insertions of 1 base or more and deletions of 1 base or more in the reference sequence comprises comparing insertions of 3 bases or more and deletions of 3 bases or more in the query sequence with insertions of 3 bases or more and deletions of 3 bases or more in the reference sequence.

According to certain embodiments, methods of identifying a best match for a biological sample are provided. In certain embodiments, a method of identifying a best match for a biological sample comprises: comparing nucleic acid sequence data from a query sequence with nucleic avid sequence data from at least one reference sequence by comparing insertions of 1 base or more and deletions of 1 base or more in the query sequence with insertions of 1 base or more and deletions of 1 base or more in the reference sequence: and determining if the query sequence matches at feast one reference sequence by the comparison of insertions of 1 base or more and deletions of 1 base or more, wherein the nucleotide sequence data from the query sequence is collected in less than 30 minutes. In certain such embodiments, the sequence data from the query sequence has an error rats selected from an at least 0.1% error rate, an at least a 0.5% error rate, an at least a 3% error rate, an at least a 5% error rate, an at least a 7% error rate, an at least a 9% error rate, an at least a 10% error rate, an at least a 12% error rate, an at least a 14% error rate, an at least a 16% error rate, an at least an 18% error rate, or an at least a 20% error rate. In certain embodiments, the sequence data from the reference sequences has at least a 0.3% error rate. In certain embodiments, the at least one reference sequence comprises a reference database of genomic sequences. In certain embodiments, the biological sample is from a source selected from: a human, a plant, an animal, bacteria, a fungus, or a virus. In certain embodiments, the comparing nucleotide sequence data from a query sequence with at least one reference comprises using an alignment tool. In certain embodiments, the nucleic acid sequence data from the query sequence is collected in an amount of time selected from: less than 45 minutes, less than 1 hour, less than 2 hours, than 3 hours, less than 6 hours, less than 12 hours, less than 18 hours, or less than 24 hours. In certain embodiments, the determining if the query sequence matches at least one reference sequence results in an exact match. In certain embodiments, the comparing insertions of 1 base or more and deletions of 1 base or more in the query sequence with insertions of 1 base or more and deletions of 1 base or more in the reference sequence comprises comparing insertions of 2 bases or more and deletions of 2 bases or more in the query sequence with insertions of 2 bases or more and deletions of 2 bases or more in the reference sequence. In certain embodiments, the comparing insertions of 1 base or more and deletions of 1 base or more in the query sequence with insertions of 1 base or more and deletions of 1 base or more in the reference sequence comprises comparing insertions of 3 bases or more and deletions of 3 bases or more in the query sequence with insertions of 3 bases or more and deletions of 3 bases or more in the reference sequence. In certain embodiments, the biological sample is assigned to a subpopulation based upon the best match to the biological sample.

Some embodiments of the present disclosure are directed to computer program products that include a computer readable storage medium laving computer readable program code embodied in the medium. The computer code may include computer readable code to perform operations as described herein.

Some embodiments of the present disclosure are directed to a computer system that includes at least one processor and at least one memory coupled to the processor. The at least one memory may include computer readable program code embodied therein that, when executed by the at least one processor causes the at least one processor to perform operations as described herein.

Some embodiments of the present disclosure are directed to methods in which the steps are performed using at least one processor.

Unless otherwise defined, all technical and scientific terms used herein have the same meaning as commonly understood by one of ordinary skill in the art. The following detailed description includes exemplary representations of various embodiments, and is not intended to be limiting. The accompanying figures constitute a part of ibis specification and, together with the description, serve only to illustrate embodiments and are not intended to be limiting.

### BRIEF DESCRIPTION OF THE FIGURES

FIG. 1 is a graph showing identification of NA07037 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 5. The y-axis represents significance and the x-axis represents the number of reads.

FIG. 2 is a graph showing identification of NA07051 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 6. The y-axis represents significance and the x-axis represents the number of reads.

FIG. 3 is a graph showing identification of NA10847 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 7. The y-axis represents significance and the x-axis represents the number of reads.

FIG. 4 is a graph showing identification of NA12249 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 8. The y-axis represents significance and the x-axis represents the number of reads.

FIG. 5 is a graph showing identification of NA12716 from the 3000 Genomes Project using reads with error rates of 0.1%, 0.5%, 1%, 3%, 5%, 7%, 9%, 10%, 12%, 14%, 16%, 18%, and 20% of nucleotides, as described in Example 9. The y-axis represents significance and the x-axis represents the number of reads.

FIG. 6 is a graph showing identification of NA12717 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 10. The y-axis represents significance and the x-axis represents the number of reads.

FIG. 7 is a graph showing identification of NA12750 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 11. The y-axis represents significance and Ute x-axis represents the number of reads.

FIG. 8 is a graph showing identification of NA12751 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 12. The y-axis represents significance and the x-axis represents the number of reads.

FIG. 9 is a graph showing identification of NA12761 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 13. The y-axis represents significance and the x-axis represents the number of reads.

FIG. 10 is a graph showing identification of NA12763 from the 1000 Genomes Project using reads with error rates of 0.1%, 0.5%, 1%, 3%, 5%, 1%, 9%, 10%, 12%, 14%, 16%, 18%, and 20% of nucleotides, as described in Example 14. The y-axis represents significance and the x-axis represents the number of reads.

FIG. 11 is a graph showing identification of NA18511 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 15. The y-axis represents significance and the x-axis represents the number of reads.

FIG. 12 is a graph showing identification of NA18517 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 16. The y-axis represents significance and the x-axis represents the number of reads.

FIG. 13 is a graph showing identification of NA18523 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 17. The y-axis represents significance and the x-axis represents the number of reeds.

FIG. 14 is a graph showing identification of NA18960 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 18. The y-axis represents significance and the x-axis represents the number of reads.

FIG. 15 is a graph showing identification of NA18961 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 19. The y-axis represents significance and the x-axis represents the number of reads.

FIG. 16 is a graph showing identification of NA18964 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 20. The y-axis represents significance and the x-axis represents the number of reads.

FIG. 17 is a graph showing identification of NA19098 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 21. The y-axis represents significance and the x-axis represents the number of reads.

FIG. 18 is a graph showing identification of NA19119 from the 1000 Genomes Project using reads with error rates of 0.1%, 0.5%, 3%, 3%, 5%, 7%, 9%, 10%, 12%, 14%, 16%, 18%, and 20% of nucleotides, as described in Example 22. The y-axis represents significance and the x-axis represents the number of reads.

FIG. 19 is a graph showing identification of NA19131 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 23. The y-axis represents significance and the x-axis represents the number of reads.

FIG. 20 is a graph showing identification of NA19152 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 24. The y-axis represents significance and the x-axis represents the number of reads.

FIG. 21 is a graph showing identification of NA19160 from the 1000 Genomes Project using reads with error rates of 0.1%, 0.5%, 1%, 3%, 5%, 7%, 9%, 10%, 12%, 14%, 16%, 18%, and 20% of nucleotides, as described In Example 25. The y-axis represents significance and the x-axis represents the number of reads.

FIG. 22 is a graph showing base call confidence scores for NA18959, as described in Example 26.

FIG. 23 is a graph showing base call confidence scores for NA18511, as described in Example 26.

FIG. 24 is a graph showing base call frequencies for NA18959, as described in Example 26.

FIG. 25 is a graph showing base call frequencies for NA18511, as described in Example 26.

FIG. 26 is a graph showing identification of NA18959 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 26. The y-axis represents significance and the x-axis represents the number of reads.

FIG. 27 shows a summary graph of the identification of NA07051, NA12717, NA12750, NA12751, NA12761, NA19098, NA19131, NA19152, NA19160, NA07037, NA12249, NA12763, NA18511, NA18517, NA18523, NA18960, NA18964, NA19119, NA10847, and NA12716 using reads with error rates of 0.1%, 0.5%, 1%, 3%, 5%, 7%, 9%, 10%, 12%, 14%, 16%, 18%, and 20% of nucleotides, as described in Example 27.

FIG. 28 shows an example of the insertion lengths for individual NA18511 depicted as a histogram, as described in Example 28.

FIG. 29 is a graph showing identification of NA07051 from the 1000 Genomes Project using reads modified to include additional random nucleotides inserted at random positions of the sampled reads at frequencies Of 0.5%, 1%, 3%, 5%, 7%, 9%, 10%, and 20%, as described in Example 29. The y-axis represents significance and the x-axis represents the number of reads.

FIG. 30 is a graph showing identification of NA10847 from the 1000 Genomes Project using reads modified to include additional random nucleotides inserted at random positions of the sampled reads at frequencies of 0.5%, 1%, 3%, 5%, 7%, 9%, 10%, and 20%, as described in Example 30. The y-axis represents significance and the x-axis represents the number of reads.

FIG. 31 is a graph showing identification of NA12716 from the 1000 Genomes Project using reads modified to include additional random nucleotides inserted at random positions of the sampled reads at frequencies of 0.5%, 1%, 3%, 5%, 7%, 9%, 10%, and 20%, as described in Example 31. The y-axis represents significance and the x-axis represents the number of reads.

FIG. 32 is a graph showing identification of NA12717 from the 1000 Genomes Project using reads modified to include additional random nucleotides inserted at random positions of die sampled reads at frequencies of 0.5%, 1%, 3%, 5%, 7%, 9%, 10%, and 20%, as described in Example 32. The y-axis represents significance and the x-axis represents the number of reads.

FIG. 33 is a graph showing identification of NA12750 from the 1000 Genomes Project using reads modified to include additional random nucleotides inserted at random positions of the sampled reads at frequencies of 0.5%, 1%, 3%, 5%, 7%, 9%, 10%, and 20%, as described in Example 33. The y-axis represents significance and the x-axis represents the number of reads.

FIG. 34 is a graph showing identification of NA12751 from the 1000 Genomes Project using reads modified to include additional random nucleotides inserted at random positions of the sampled reads at frequencies of 0.5%, 1%, 3%, 5%, 7%, 9%, 10%, and 20%, as described in Example 34. The y-axis represents significance and the x-axis represents the number of reads.

FIG. 35 is a graph showing identification of NA12761 from the 1000 Genomes Project using reads modified to include additional random nucleotides inserted at random positions of the sampled reads at frequencies of 0.5%, 1%, 3%, 5%, 7%, 9%, 10%, and 20%, as described in Example 35. The y-axis represents significance and the x-axis represents the number of reads.

FIG. 36 is a graph showing identification of NA19098 from the 1000 Genomes Project using reads modified to include additional random nucleotides inserted at random positions of the sampled reads at frequencies of 0.5%, 1%, 3%, 5%, 7%, 9%, 10%, and 20%, as described in Example 36. The y-axis represents significance and the x-axis represents the number of reads.

FIG. 37 is a graph showing identification of NA19131 from the 1000 Genomes Project using reads modified to include additional random nucleotides inserted at random positions of the sampled reads at frequencies of 0.5%, 1%, 3%, 5%, 7%, 9%, 10%, and 20%, as described in Example 37. The y-axis represents significance and the x-axis represents the number of reads.

FIG. 38 is a graph showing identification of NA19152 from the 1000 Genomes Project using reads modified to include additional random nucleotides inserted at random positions of the sampled reads at frequencies of 0.5%, 1%, 3%, 5%, 7%, 9%, 10%, and 20%, as described in Example 38. The y-axis represents significance and the x-axis represents the number of reads.

FIG. 39 is a graph showing identification of NA19160 from the 1000 Genomes Project using reads modified to include additional random nucleotides inserted at random positions of the sampled reads at frequencies of 0.5%, 1%, 3%, 5%, 7%, 9%, 10%, and 20%, as described in Example 39. The y-axis represents significance and the x-axis represents the number of reads.

FIG. 40 shows a summary graph of the identification of NA07051, NA10847, NA12716, NA12717, NA12750, NA12751, NA12761, NA19098, NA19131, NA19152, and NA19160 using reads modified to include additional random nucleotides inserted at random positions of the sampled reads at frequencies of 0.5%, 1%, 3%, 5%, 7%, 9%, 10%, and 20%, as described in Example 40.

FIG. 41 is a graph showing identification of NA18959 from the 1000 Genomes Project using reads modified to include additional random nucleotides inserted at random positions of me sampled reads at frequencies of 0.5%, 1%, 3%, 5%, 7%, 9%, 10%, and 20%, as described in Example 41. The y-axis represents significance and the x-axis represents the number of reads.

FIG. 42 is a graph showing identification of NA07051 from the 1000 Genomes Project using reads modified to include substitution errors at a rate of 3% of bases as welt as insertion errors at frequencies of 0.5%, 1%, 5%, 7%, 9%, 10%, and 20% of reads, as described in Example 42. The y-axis represents significance and the x-axis represents the number of reads.

FIG. 43 is a graph showing identification of NA10847 from the 1000 Genomes Project using reads modified to include substitution errors at a rate of 3% of bases as well as insertion errors at. frequencies of 0.5%, 1%, 3%, 5%, 7%, 9%, 10%, and 20% of reads, as described in Example 43. The y-axis represents significance and the x-axis represents the number of reads.

FIG. 44 a graph showing identification of NA12716 from the 1000 Genomes Project using reads modified to include substitution errors at a rate of 3% of bases as well as Insertion errors at frequencies of 0.5%, 1%, 3%, 5%, 7%, 9%, 10%, and 20% of reads, as described in Example 44. The y-axis represents significance and the x-axis represents the number of reads.

FIG. 45 is a graph showing identification of NA12717 from the 1000 Genomes Project using reads .modified to include substitution errors at a rate of 3% of bases as well as insertion errors at frequencies of 0.5%, 1%, 3%, 5%, 7%, 9%, 10%, and 20% of reads, as described in Example 45. The y-axis represents significance and the x-axis represents tike number of reads.

FIG. 46 is a graph showing identification of NA12750 from the 1000 Genomes Project using reads modified to include substitution errors at a rare of 3% of bases as well as insertion errors at frequencies of 0.5%, 1%, 3%, 5%, 7%, 9%, 10%, and 20% of reads, as described in Example 46. The y-axis represents significance and the x-axis represents the number of reads.

FIG. 47 is a graph showing identification of NA12751 from the 1000 Genomes Project using reads modified to include substitution errors at a rate of 3% of bases as welt as insertion errors at frequencies of 0.5%, 1%, 3%, 5%, 7%, 9%, 10%, and 20% of reads, as described in Example 47. The y-axis represents significance and the x-axis represents the number of reads.

FIG. 48 is a graph showing identification of NA12761 from the 1000 Genomes Project using reads modified to include substitution errors at a rate of 3% of bases as well as insertion errors at frequencies of 0.5%, 1% 3%, 5%, 7%, 9%, 10%, and 20% of reads, as described in Example 48. The y-axis represents significance and the x-axis represents the number of reads.

FIG. 49 is a graph showing identification of NA19098 from the 1000 Genomes Project using reads modified to include substitution errors at a rate of 3% of bases as well as insertion errors at frequencies of 0.5%, 1%, 3%, 5%, 7%, 9%, 10%, arid 20% of reads, as described in Example 49. The y-axis represents significance and the x-axis represents the number of reads.

FIG. 50 is a graph showing identification of NA19131 from the 1000 Genomes Project using reads modified to include substitution, errors at a rate 3% of bases as well as insertion errors frequencies of 0.5%, 1%, 3%, 5%, 7%, 9%, 10%, and 20% of rends, as described in Example 50. The y-axis represents significance and the x-axis represents the number of reads.

FIG. 51 is a graph showing identification of NA19160 from the 1000 Genomes Project using reads modified to include substitution errors at a rate of 3% of bases as well as insertion errors at frequencies of 0.5%, 1%, 3%, 5%, 7%, 9%, 10%, and 20% of reads, as described in Example 51. The y-axis represents significance and the x-axis represents the number of reads.

FIG. 52 shows a summary graph of the identification of NA07051, NA10847, NA12716, NA12717, NA12750, NA12751, NA12761, NA 19098, NA19131, and NA19160 using reads modified to include substitution errors at a rate of 3% of bases as well as insertion errors at frequencies of 0.5%, 1%, 3%, 5%, 7%, 9%, 10%, and 20% of reads, as described in Example 52.

FIG. 53 is a graph showing identification of NA07051 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 53. The y-axis represents significance and the x-axis represents the number of reads.

FIG. 54 is a graph showing identification of NA12761 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 54. The y-axis represents significance and the x-axis represents the number of reads.

FIG. 55 is a graph showing identification of NA07051 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 55. The y-axis represents significance and the x-axis represents the number of reads.

FIG. 56 is a graph showing identification of NA12761 from the 1000 Genomes Project using reads with error rates of 0.1%, 0.5%, 1%, 3%, 5%, 7%, 9%, 10%, 12%, 14%, 16%, 18%, and 20% of nucleotides, as described in Example 56. The y-axis represents significance and the x-axis represents the number of reads.

FIG. 57 is a boxplot showing assignment of individuals from the 1000 Genomes Project to subpopulations, as described in Example 57.

FIG. 58 illustrates a data processing system that may be used to implement any one or more of the components according to some embodiments of the present disclosure.

FIG. 59 illustrates a block diagram of a software and hardware architecture for identifying individuals according to some embodiments of the present disclosure.

### DETAILED DESCRIPTION OF THE INVENTION

The section headings used herein are for organizational purposes only and are not to be construed as limiting me subject matter described.

Unless otherwise defined herein, scientific and technical terms used in connection with the present specification and claims shall have the meanings that are commonly understood by those of ordinary skill in the art. Generally, nomenclatures used in connection with, and techniques of molecular biology, microbiology, genetics, biometrics, computer programming, and protein and oligo- or polynucleotide chemistry, amplification, hybridization, detection, and sequencing thereof, described herein are those well known and commonly used in the art.

The following terms, unless otherwise indicated, shall be understood to have the following meanings:

The term “biological sample” refers to any biological material from which nucleic acids can be derived. Examples of biological samples include, but are not limited to, tissue, hair, saliva, cheek swabs, blood, semen, tears, cells, fingernails, toenails, skin, scales, feathers, leaves, roots, vines, flowers, pollen grains, bark, and ecological samples such as water or soil. In certain embodiments, biological samples may encompass entire organisms, e.g., bacteria, viruses and eukaryotic single-cell organisms. In certain embodiments, a biological sample may comprise genomes from multiple different organisms. For example, and not limitation, an individual may provide a saliva sample, which includes the individual's nucleic acids, as well as the nucleic acids of microbial organisms. In certain embodiments, a biological sample contains only nucleic acids from a single organism, for example, and not limitation, nucleic acids extracted from the blood of an individual.

The term “nucleic acid sequence data” refers to any sequence data collected from nucleic acids. Nucleic acids from which nucleic acid sequence data can be collected include, hut are not limited to, genomic DNA, RNA, cDNA, viral genomic RNA, mitochondrial DNA, chloroplast DNA, plasmids, BACs, YACs, cosmids, or DNA housed in other vectors. In certain embodiments, nucleic acid sequence data is collected from at least one of naturally occurring nucleic acids and non-naturally occurring nucleic acids. In certain embodiments, nucleic acid sequence data will be generated in short fragments referred to in the art as “reads” or “lags”. Reads range in length from “short” (for example, and not limitation, 20 bases) to “lung” (for example, and not limitation, multiple kilobases).

Methods of sequencing are known in the art. Examples of sequencing methods known in the art include, but are not limited to, Maxim-Gilbert sequencing, Sanger sequencing, Massively Parallel Signature Sequencing, Polony Sequencing, 454 Pyrosequencing, Illumina (Solexa) sequencing, SOLiD (ligation) sequencing, Ion Semiconductor Sequencing, DNA nanoball sequencing, Heliscope single molecule sequencing, single molecule real time sequencing, nanopore sequencing, hybridization based sequencing, mass spectrometry sequencing, microfluidic Sanger sequencing, microscopy based sequencing, RNA polymerase based sequencing, in vitro virus high-throughput sequencing, amplicon based sequencing, sequencing with a targeted enrichment step (including, but not limited to, enrichment by biotinylated oligos (in-solution hybrid capture), enrichment by PCR amplification, enrichment by microarray (on-array hybrid capture), and enrichment by molecular inversion probes (MIPS)).

The term “genomic sequence” refers to nucleic acid sequence data collected from genomic nucleic acids. In certain embodiments, genomic sequence is collected from genomic DNA. In certain embodiments, genomic sequence is collected from total RNA. In certain embodiments, genomic sequence is collected from mitochondrial or chloroplast DNA. In certain embodiments, genomic sequence is collected from genomic nucleic acids that are first inserted into a cloning vector. For example and not limitation, genomic sequence can be collected from genomic nucleic acid cloned into a plasmid, YAC, BAC, cosmid, or the like.

The term “reference sequence” refers to nucleic acid sequence data that is used for comparison to other nucleic acid sequences. In certain embodiments, reference sequences may be collected in a database.

The term “reference database of genomic sequences” refers to a database comprising one or more reference sequences derived from genomic sequences. In certain embodiments, a reference database of genomic sequences may also comprise additional reference sequences derived from non-genomic sequences. Methods of creating databases of genomic sequences are known in the art, for example and not limitation, the methods described in Langmead, B. et at., Genome Biology, 10(3), p. R25 2009; Li, H & Durbin, R., Bioinformatics (Oxford, England), 26(5), pp. 589-595 2010; Li, H. et at. The sequence alignment/map format and SAMtools Bioinformatics, 2009 Aug. 15; 25(16):2078-9. In certain embodiments, a reference database of genomic sequences may comprise the full genomic sequence of at least one individual. In certain embodiments, a reference database of genomic sequences may comprise sequences that are informative from one or more individuals, but not the full genomic sequences of the one or more individuals. An “informative sequence” or “informative site” is one that varies in a population, and may thus serve to help identify individuals.

The term “query sequence” refers to nucleic acid sequence data that is compared to one or more reference sequences. In certain embodiments, the query sequence comprises one or more assembled sequences. “Assembled sequences” are sequences assembled by putting together information from two or more reads. For example, and not limitation, a query sequence from a human may comprise 46 different sequences, with each sequence corresponding to most or all of me complete sequence of a different human chromosome from the same biological source. In certain embodiments, the query sequence comprises one or more reads. For example, and not limitation, a query sequence from a human may comprise one million individual reads from a single biological source. In certain such embodiments, those reads are not assembled into contiguous sequences prior to being compared to one or more reference sequences, but are compared directly to one or more reference sequences without being assembled into longer sequences. In certain embodiments, the query sequence comprises one or more reads and one or more assembled sequences.

The term “sequence error rate” refers to the rate at which errors occur in the nucleic acid sequence data relative to the actual sequence of the nucleic acid in the sample. For example, and not limitation, a sequence error rare of 25% indicates that 1 out of every 4 bases is incorrect in the nucleic acid sequence data. In certain embodiments, the sequence error rate may be above 0% in the query sequence. In certain embodiments, the sequence error rate may be above 0% in the reference sequence. In certain embodiments, the sequence error rate may be above 0% in both the query sequence and the reference sequence.

The term “inherent error rate” refers to the error rate of nucleic acid sequence data, which may correspond to errors caused by different sequencing platforms. In certain embodiments, different sequencing, platforms have different inherent error rates. In certain embodiments, one or more sequencing platforms have the same inherent error rate. Differences in the quality of the DNA sample, or the method of sample preparation, can also cause different inherent error rates.

The terms “added error rate” and “additional error rate” refer to the error rate of nucleic acid sequence data wherein additional errors are purposely added to nucleic acid sequence data, as described herein in certain examples.

The term “total error rate” refers to the sum of the inherent error rate and the added error rate in nucleic acid sequence data.

The term “insertion”, when used in reference to bases in a query sequence, refers to the insertion of 1 or more bases in the query sequence in comparison to a reference sequence.

The term “deletion”, when used in reference to bases in a query sequence, refers to the deletion of 1 or more bases in the query sequence in comparison to a reference sequence.

The term “alignment loop” refers to any algorithm used to align a query sequence with at least one reference sequence according to the similarity of the nucleic acid sequences. In certain embodiments, alignment tools are used to compare a query sequence with one or more reference sequences in a database of genomic sequences. Alignment tools and methods of using them are known in the art, and include, but are not limited to, BLAST, BLAT, MAQ, ELAND, RMAP, SOAP, SOAP II, NovoAlign, SHRiMP, GSNAP, Bowtie, the Burrow-Wheeler Aligner, other implementations of the Burrows-Wheeler Transform, suffix/prefix trees/tries, other trees/tries, hashtables, and the examples and methods found in U.S. Pat. Nos. 7,585,466; 8,108,384; 8,280,650; and U.S. Patent Application Nos. 2008/0077607; 2011/0093426 and 2011/0067108 and 2013/0103951. In certain embodiments, alignment tools are custom aligners, which are alignment tools that are modified from existing alignment tools, or alignment tools that are created de novo.

The term “best match”, when used to describe the relationship between a query sequence and reference sequence, refers to the reference sequence that possesses the sequence most similar to the query sequence according to the informative sequences or sites being evaluated.

The term “exact match” when used to describe the relationship between a query sequence and reference sequence refers to a reference sequence derived from the same biological sample as the query sequence.

The best match for a query sequence may or may not be an exact match for a query sequence. In certain embodiments, an exact match for a query sequence is also a best match for a query sequence.

In certain embodiments, the best match for a query sequence is not a reference sequence from the same biological sample as the query sequence. In certain such embodiments, the reference sequence is from a biological sample that is genetically related to the biological sample used to create the query sequence. Examples of biological samples that are genetically related include, but are not limited to, siblings, parents, children, cousins, uncles, aunts, and extended family members.

The phrase “determining if the query sequence matches at least one reference sequence” refers to a case where the query sequence is a best match to a particular reference sequence by at least one definition of sequence similarity. In certain embodiments, the query sequence is an exact match to a reference sequence by at least one definition of sequence similarity. Definitions of sequence similarity are known in the art, and include but are not limited to: simple comparison and enumeration of mismatches, similarities in patterns of substitutions and deletions, similarity as determined by a software package such as Bowtie, BLAST, or any number of other related DNA sequence comparison algorithms, Hamming distance, Euclidian distance, edit distance and information distance.

The phrase “the nucleic acid sequence data from the query sequence is collected” in a specified amount of tune refers to the time between when a biological sample is ready for sequencing and the time at which enough sequence data is collected from that biological sample to determine if the sample matches at least one reference sequence. The phrase “the nucleic acid sequence data from the query sequence is collected” does not include the time required to acquire the biological sample or the time required to prepare the biological sample for sequencing.

In certain embodiments, nucleic acid sequence data born a query sequence is collected in less than 30 minutes. In certain embodiments, nucleic acid sequence data from a query sequence is collected in less than 45 minutes. In certain embodiments, nucleic acid sequence data from a query sequence is collected in less than 1 hour. In certain embodiments, nucleic acid sequence data from a query sequence is collected in less than 2 hours. In certain embodiments, nucleic acid sequence data from a query sequence is collected in less than 3 hours. In certain embodiments, nucleic acid sequence data from a query sequence is collected m less than 6 hours. In certain embodiments, nucleic acid sequence data from a query sequence is collected in less than 12 hours. In certain embodiments, nucleic acid sequence data from a query sequence is collected in less than 18 hours. In certain embodiments, nucleic acid sequence data from a query sequence is collected in less than 24 hours.

The term “subpopulation” refers to a set of individuals within a larger population of individuals. In certain embodiments, a subpopulation comprises individuals with certain nucleic acid sequence similarities between individuals within the subpopulation. In certain embodiments, sets of subpopulations may be mutually exclusive. In certain embodiments, sets of subpopulations may be overlapping. In certain embodiments, subpopulations may be strict subsets of other subpopulations. In curtain embodiments, an individual within a population may have nucleic acid sequences that are more similar to nucleic acid sequences of other individuals within the same subpopulation than to the nucleic acid sequences of individuals outside of the subpopulation. In certain embodiments, any two individuals within a subpopulation may have a higher degree of nucleic acid sequence similarity than the similarity that exists between any individual in that same subpopulation and any individual not in that subpopulation. In certain embodiments a subpopulation may be represented by a single individual within the population in the reference database of genomic sequences. In certain embodiments a subpopulation may have a single individual within the population in the reference allele database. In certain embodiments, subpopulation may refer to family members. In certain embodiments, subpopulation may refer to ethnic group. In certain embodiment, subpopulation may refer to species identity. In certain embodiments, subpopulation may refer to a bacterial, viral, or single-celled eukaryotic strain. In certain embodiments, the subpopulation may refer to any taxonomic clade.

### Exemplary Methods of Identifying Individuals

In certain embodiments, a synthetic reference is constructed. In certain such embodiments, the synthetic reference comprises alternate alleles and reference alleles for informative sequences and informative sites in a reference database of genomic sequences. For example, and not limitation, a synthetic reference might comprise the genomic positions of insertions and deletions of 3 bases and more in the reference database of genomic sequences. In certain embodiments, a synthetic reference might comprise the genomic positions of insertions and deletions of 2 bases and more in the reference database of genomic sequences. In certain embodiments, a synthetic reference might comprise the genomic positions of insertions and deletions of 1 base and more in the reference database of genomic sequences. In certain embodiments, a synthetic reference can comprise the genomic positions of insertions and deletions of any length and the genomic positions of other informative sequences or informative sites, such as, for example, and not limitation, single nucleotide polymorphisms.

In certain embodiments, creating a synthetic reference comprising the genomic positions of insertions and deletions provides a computational efficiency advantage compared to creating a synthetic reference comprising primarily single nucleotide polymorphisms. For example, and not limitation, in certain embodiments, the higher genomic frequency at which single nucleotide polymorphisms occur with respect to insertions or deletions means that one will have to analyze a greater number of informative sequences and informative sites in sequences with or without higher rates of base substitution errors when using a synthetic reference comprised primarily of single nucleotide polymorphisms rather than a synthetic reference comprising the genomic positions of insertions and deletions. In certain embodiments, the use of a larger number of informative sequences will reduce the computational efficiency of an alignment tool.

In certain embodiments, a reference database of genomic sequences is indexed. In certain embodiments, indexing a reference database comprises tagging information so that it can be retrieved more quickly and/or more efficiently. In certain embodiments, the synthetic reference is indexed. For example, and not limitation, a synthetic reference can be indexed with Bowtie. In certain embodiments, a synthetic reference can also be indexed with the BWA. In certain embodiments, a synthetic reference can also be indexed with a non-overlapping k-mer index, as with BLAT. In certain embodiments, a synthetic reference may be indexed with other implementations of the Burrows-Wheeler transform. In certain embodiments, a synthetic reference may be indexed with suffix/prefix trees/tries or other trees/tries. In certain embodiments, a synthetic reference may not be indexed.

In certain embodiments, the locations of informative sequences und informative sites in a reference database of genomic sequences and the alternate alleles for those informative sequences and informative sites are specified in the synthetic reference. Methods of specifying locations in a reference include any file formal that has the ability to denote a position in the genome, and are known in the art. For example, and not limitation, a BED formatted file is one method to the an of specifying locations in a reference. Other file formats known in the art to denote genome positions include but are not limited to wiggle, BAM, SAM, bigWig, bigBed, bedGraph, or other delimited files with genomic locations.

In certain embodiments, a query sequence is mapped against one or more reference sequences. In certain embodiments, the one or more references are included in a reference database of genomic sequences. In certain embodiments, a reference database of genomic sequence may not be required. In certain embodiments, the database may contain transcriptomic sequences, as generated from RNA sequencing. In certain embodiments, the query sequence is mapped using an alignment tool. In certain embodiments, the stringency of the mapping can be adjusted. Methods of adjusting the stringency of the mapping include, but are not limited to, varying one or more parameters that affect stringency, such as, for example, and not limitation, adjusting the stringency of the mapping such that more or fewer base mismatches are tolerated, adjusting the stringency of the mapping such that a greater or lesser number of insertions or deletions are tolerated, adjusting the stringency of the mapping such that insertions and/or deletions of various sizes are tolerated, adjusting the stringency of the mapping such that different lengths of DNA sequence are used to perform the alignment, adjusting the stringency of the mapping such that different portions of each DNA sequence are used to perform the alignment, adjusting the stringency of the maiming such that a query sequence is permitted to have only a single match to different positions in the reference, and adjusting the stringency of the mapping such that a query sequence may march the reference multiple times. In certain embodiments, the number of mismatches permitted is 1, 2, 3, 4, 5, 6, 7, 8, 9, 10, 11, 12, 13, 14, 15, or any natural number up to and including 20% of the length of the sequencing read. In certain embodiments, the number of mismatches permitted may be restricted to portions of the sequencing read. In certain embodiments, the number of mismatches permitted may be 0. In certain embodiments, the number of mismatches within a portion of the sequencing read may be 0.

In certain embodiments, reads mapping to alternate alleles for informative sequences and informative sites are identified. In certain embodiments, reads mapping to reference alleles for informative sequences and informative sites are identified. In certain embodiments, reads mapping to reference alleles and alternate alleles for informative sequences and informative sites are identified.

In certain embodiments, alternate allele calls for a given individual are compared to calls for all individuals of the reference database of genomic sequences. In certain such embodiments, if an individual was called homozygous for the reference allele at a given position where an alternate allele is defined, it is counted as one inconsistency for that individual. In certain such embodiments, inconsistencies are totaled for each individual. In certain such embodiments, the individual with the lowest number of inconsistencies is deemed the most likely identity of the sample. In certain such embodiments, the remaining individuals in the reference database of genomic sequences are used to estimate the confidence of the identity determination.

In certain embodiments, reference allele calls for a given individual are compared to calls for all individuals of the reference database of genomic sequences. In certain such embodiments, if an individual was called homozygous for the alternate allele at a given position where a reference allele is defined, it is counted as one inconsistency for that individual. In certain such embodiments, inconsistencies are totaled for each individual. In certain such embodiments, the individual with the lowest number of inconsistencies is deemed the best match for the sample. In certain such embodiments, the remaining individuals in the reference database of genomic sequences are used to estimate the confidence of the identity determination.

In certain embodiments, inconsistencies in alternate alleles, as described above, are combined with inconsistencies in reference alleles, as above. In certain such embodiments, combined inconsistencies are totaled for each individual. In certain such embodiments, the individual with the lowest number of combined inconsistencies is deemed the most likely identity of the sample. In certain such embodiments, the remaining individuals in the reference database of genomic sequences are used to estimate the confidence of the identity determination.

In certain embodiments, the reference index or the comparison to that index may be organized in such a way to speed the comparison. For example, and not limitation, a small number of reference sequences may be selected for an initial comparison that then guides the search to different bins of reference sequences that are themselves organized by similarity to each other. For example, and not limitation, the individuals within the reference chosen fox the initial search can be selected based on the fact that they are the individuals maximally different from each other in the reference database.

In certain embodiments, an individual may be assigned to one or more subpopulations. In certain embodiments, assignment of a query individual to one or more subpopulations may be performed by determining the individual in the reference database of genomic sequences with the individual that is the best match, and assigning the query individual to the same subpopulations as the best match individual. In certain embodiments, a metric of similarity between the individual and each member of the reference database of genomic sequences may be generated. In certain embodiments, the metrics of similarity for individuals in each population may be used to generate distribution of similarity between the query individual and each subpopulation. In certain embodiments, a distribution of similarly between the query individual and members of the subpopulation versus members not in the subpopulation may be used to assign the individual to a subpopulation. In certain embodiments, multiple distributions of similarity between the query individual and multiple mutually exclusive subpopulations may be used to assign the individual to the most likely subpopulation. In certain embodiments, the known size of the subpopulation within the larger population may be used to improve the determination of likelihood that an individual belongs to a certain subpopulation, with larger subpopulations being more likely.

In some embodiments, the methods further comprise a step of obtaining a biological sample In some embodiments, the methods further comprise a step of isolating DNA or other nucleic acids from the biological sample. In some embodiments, the methods further comprise a step of sequencing at least a portion of the isolated DNA or other nucleic acid. Each of these steps can be carried out by routine techniques well known in the art.

In some embodiments, the methods further comprise a step of carrying out an action based on the results of comparing nucleic acid sequence data and determining if the query sequence matches at least one reference sequence. In certain embodiments, the action can be different if a match is found and if a match is not found. Actions can include, without limitation, providing a signal (e.g., physical or electronic) indicating a match/no match, providing a printout or display indicating a match/no match, and/or actuating a device (e.g., a lock, door, container, bell, buzzer, computer, printer, camera).

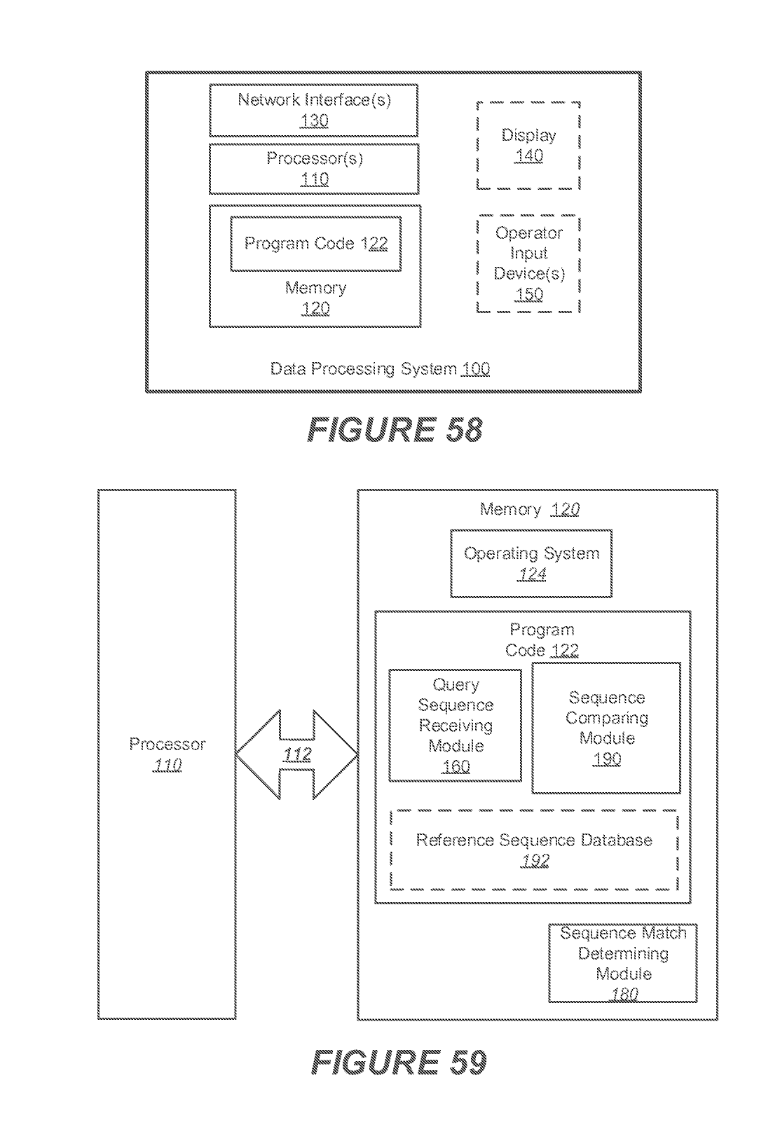

Referring now to FIG. 58, a data processing system 100 that may be used to implement one or more of the components of the invention, according to some embodiments of the present disclosure, includes one or more network interfaces 130, processor circuitry (“processor”) 110, and memory 120 containing program code 122. The processor 110 may include one or more data processing circuits, such as a general purpose and/or special purpose processor (e.g., microprocessor and/or digital signal processor) that may be collocated or distributed across one or more networks. The processor 110 is configured to execute program code 122 in the memory 120, described below as a computer readable storage medium, to perform some or all of the operations and methods that are described above for one or more of the embodiments, such as the embodiments disclosed herein. The data processing system 100 may also include a display device 140 and/or an operating input device 150, such as a keyboard, touch sensitive display device, etc. The network interface 130 can be configured to communicate through one or more networks with any one or more servers, databases, etc.

FIG. 59 illustrates a processor 110 and memory 120 that may be used in embodiments of data processing systems 100. The processor 110 communicates with the memory 120 via an address/data bus 112. The program code 122 may include a query sequence receiving module 160, a sequence comparing module 190, a sequence match determining module 180, and/or a reference sequence database 192. The memory 120 may further include an operating system 124 that generally controls the operation of the data processing system. In particular, the operating system 124 may manage the data processing system's software and/or hardware resources and may coordinate execution of programs by the processor 110.

As will be appreciated by one skilled in the art, aspects of the present disclosure may be illustrated and described herein in any of a number of patentable classes or context including any new and useful process, machine, manufacture, or composition of matter, or any new and useful improvement thereof.

In some embodiments, the methods of the invention are computer-implemented methods. In some embodiments, at least one step of the methods of the invention is performed using at least one processor. In certain embodiments, all of the steps of the methods of the invention are perforated using at least one processor. Further embodiments are directed to a system for carrying out the methods of the invention. The system can include, without limitation, at least one processor and/or memory device.

Accordingly, aspects of the present disclosure may be implemented entirely in hardware, entirely in software (including firmware, resident software, micro-cods, etc.) or by combining software and hardware implementation that may all generally be referred to herein as a “circuit,” “module,”“component,” or “system.”Furthermore, aspects of the present disclosure may lake the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Interact using an Internet Service Provider) or in a cloud computing environment or offered as a service such as a Software as a Service (SaaS).

Aspects of the present disclosure may be described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified m the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Having described the present invention, the same will be explained in greater detail in the following examples, which are included herein for illustration purposes only, and which are not intended to be limiting to the invention.

### EXAMPLES

### Example 1

### Alternate Allele Index Construction

Types, locations, and minor allele frequencies of genotypic variations observed within the 1000 Genomes Project individuals were downloaded for each chromosome and each of the 1092 individuals (ftp-trace.ncbi.nih.gov/1000genomes/ftp/ and and www.1000genomes.org/data, (phase1_release_v3.20101123)). Insertion or deletion (indel) variants were filtered using custom perl scripts (shown below) to include only those where the minor allele was at least 3 basepairs (bp) in length when compared to the major allele. No filtering criteria were employed for allele frequencies.

### Perl Command Line Call perl-ne ‘if (substr($_,0,1)ne “#”) {@A=split(t/,$_); if (abs(length($A[3])-length($A[4]))) {print $_;}}’FILENAME

For each such variant, a ‘synthetic reference’ sequence for the allele not included in the hg19 (GRCh37) human genome reference annotation was constructed. This synthetic reference was designed to imitate the sequence and sequence context of ihe non-reference allele. Therefore, in the case that the variant was an iasertion, each inserted sequence was flanked with 50 bp of the reference genome sequence on either side of the location of the variant. In the case of a deletion, the 50 bp of relerence sequence on either side of the deletion was adjoined, thus removing the deleted sequence. The use of 50 bp of flanking sequence was directed towards 50 bp sequencing reads, but could be constructed differently to handle any read length.

The resulting ‘synthetic reference’ sequences were additionally padded on both sides with 50 bp of “N” characters (representing undetermined sequence) and then concatenated to form an “alternate allele reference”. This was then appended to the hg19 reference and indexed with ‘bowtie-index’ to form the “total allele index”. A BED-formatted file was generated containing the location of every variant in the reference as well as the location of alternate alleles in the alternate allele reference. A BED formatted file is one method in the art of specifying locations in a reference, here the alternate allele reference, and is formatted with multiple Sines of the form “SequenceName \t positionStart \t positionStop”. That BED file was designated the “allelic BED file”.

### Example 2

### Read Simulation

To test the efficacy of certain methods described herein, sequencing reads from the 1000 Genomes Project were downloaded for analysis. For each of 20 individuals, one arbitrary FASTQ source file containing no less than 5,000,000 sequencing reads was chosen. Across individuals, reads varied in length from 36-100 bases. For each individual, 10,000, 50,000, 100,000, 500,000, 1,000,000, and 5,000,000 reads were randomly sampled. In cases where reads for an individual were longer than 51 bp, those reads were truncated to 50 bp. Each sampled FASTQ file contained an inherent error rate corresponding to the sequencing platform, but to test whether tiw method could tolerate additional sequencing errors, additional errors were simulated at varying rates in three categories: single base substitutions, insertions of various lengths, or a combination of both single-base substitutions and insertions of various lengths. Additional single-base substitutions were introduced by randomly selecting nucleotides and changing them to a different nucleotide chosen at random (e.g.: an A would be substituted with cither a T, C, or G). The percentage of nucleotides substituted was varied at the following frequencies: 0.1%, 0.5%, 1%, 3%, 5%, 7%, 9%, 10%, 12%, 14%, 16%, 18%, and 20%, and tins was performed for each of the read count samplings described above. To introduce insertion errors, reads were randomly selected to receive an insertion at a random position at the following rates: 0.5%, 1%, 3%, 5%, 7%, 9%, 10%, and 20% of reads. Insertion lengths were modeled from the exponential distribution, however reads were truncated back to the appropriate read length if the insertion added bases beyond the end of the read. To simulate the combination of substitution and insertion errors, the insertion error process described above was performed on FASTQ files already modified to have a 3% substitution error rate.

### Example 3

### Allele Determination from Sequencing Reads

The simulated reads, with and without additional errors generated as described above, were mapped to the total allele index using bowtie with stringent mapping conditions (<=2 bp mismatch, no insertions or deletions permitted in mapping, unique alignment required). Mapped reads were filtered using, the allelic BED file to identify reads overlapping the selected reference and alternate alleles, but without any other alignment identified elsewhere in the genome (“uniquely mapping reads”). Where mapped reads overlapped alternate alleles in the alternate allele reference or reference alleles in the hg19 sequence, that allele was treated as present in the individual being sequenced. In cases where the Individual had both alternate and reference allele mappings, that individual was treated as having both alleles present.

### Example 4

### Identification of Individuals

For each individual, a pairwise comparison was made between the alleles determined as present in the previous step to allele calls made by the 1000 Genomes Project annotations for all 1092 individuals separately. The 1000 Genomes Project Identified all individuals as ‘homozygous reference’, ‘heterozygous’, or ‘homozygous alternate’ in the various alleles used. Where an individual in the 1000 Genomes Project was identified as being ‘homozygous alternate’ or ‘homozygous reference’ for a given variant, but the pairwise comparison had identified the presence of the other allele in the sequenced individual, this was called as one ‘mismatch’ for that individual. The number of mismatches to each individual was totaled for each of the 1092 pairwise comparisons.

The number of observed mismatches between each of the 1092 individuals was used to generate an empirical distribution of the number of expected mismatches. To ensure a representative mismatch profile, simulations in which none of the individuals had at least 10 mismatches were discarded. For this implementation, a normal distribution was used with mean and standard deviation of all included individuals excluding the individual with the lowest number of mismatches, or 1091 individuals. the individual with the lowest number of mismatches was then identified. That person was considered the most likely identity. A significance estimate on this identity was generated using the empirical distribution. Significance values smaller than 1×10⁻⁹ were considered significant with regard to positively identifying an individual among the entire human population.

### Example 5

### NA07037

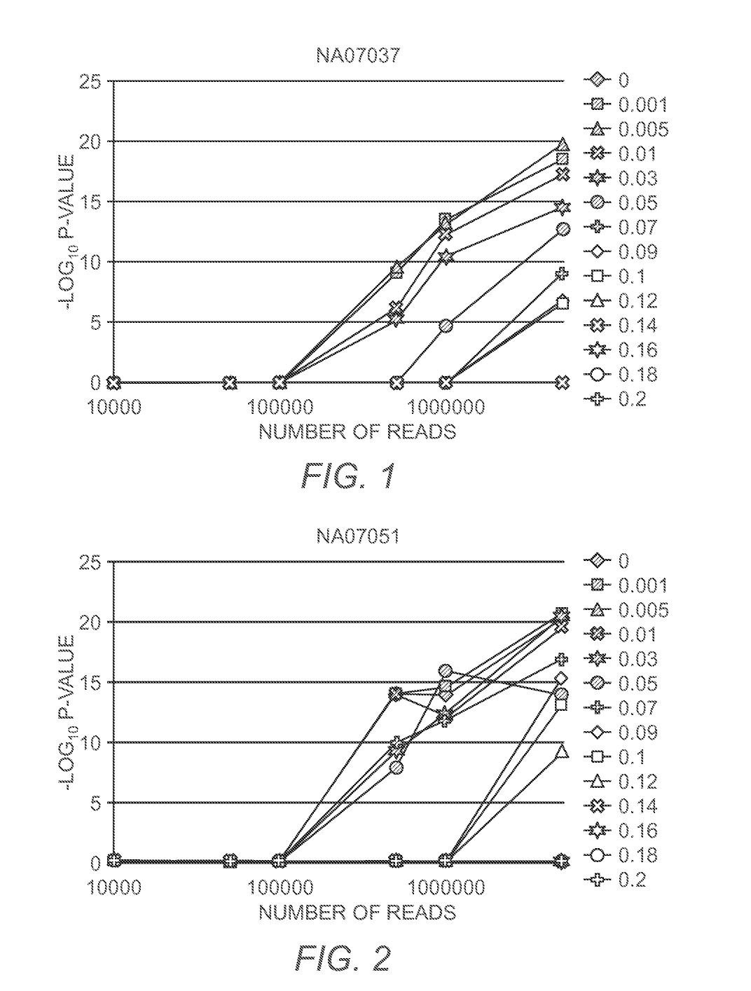

This individual is a female from the CEU (Utah residents (CEPH) with Northern and Western European ancestry) population. 10,000, 50,000, 100,000, 500,000, 1,000,000, and 5,000,000 random reads were sampled from the original sequencing file and the sequencing reads were truncated to 50 bp as described above. Fur each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated. The p-value estimates the probability that an individual distinct from the individual from whom query sequences were in fact derived could have such a low number of mismatches against the query sequences due to chance similarity in their genomes. With no errors added, the correct identity (p<1×10⁻⁹) was obtained at a sequencing depth of 500,000 reads (FIG. 1). At a depth of 1,000,000 reads, the individual was correctly identified for error rates up to 3%, and at a depth of 5,000,000 reads, the individual was correctly identified with up to 5% error (FIG. 1).

### Example 6

### NA07051

This individual is a male from the CEU population. 10,000, 50,000, 100,000, 500,000, 1,000,000, and 5,000,000 random 51-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated, representing the likelihood that the correct identity was obtained. The correct identity was obtained significantly (p<1×10⁻⁹) at a sequencing depth of 500,000 reads for 0%, 0.1%, 0.5%, 1%, and 7% error (FIG. 2). At a depth of 1,000,000 reads, the individual was correctly identified for error rates up to 7%, and at a depth of 5,000,000 reads, the individual was correctly identified with up to 10% error (FIG. 2).

### Example 7

### NA10847

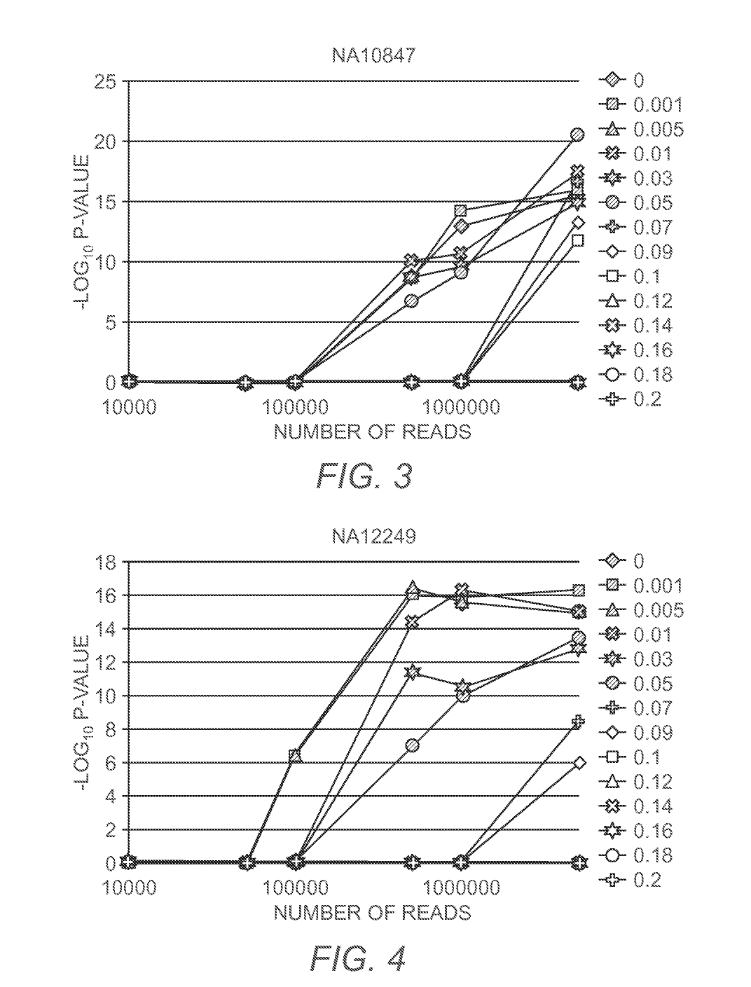

This individual is a female from the CEU population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of 1% (FIG. 3). At a depth of 1,000,000 reads, the individual was correctly identified for error rates up to 5%, and at a depth of 5,000,000 reads, the individual was correctly identified with up to 10% error (FIG. 3).

### Example 8

### NA12249

This individual is a female from the CEU population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference a p-value was calculated representing the likelihood that the correct identity was obtained. The correct identity was obtained significantly (p<1×10⁻⁹) at a sequencing depth of 500,000 reads at an emir rate of up to 3% (FIG. 4). At a depth of 1,000,000 reads, the individual was correctly identified for error rates up to 5%, and at a depth of 5,000,000 reads, the individual was correctly identified with up to 5% error (FIG. 4).

### Example 9

### NA12716

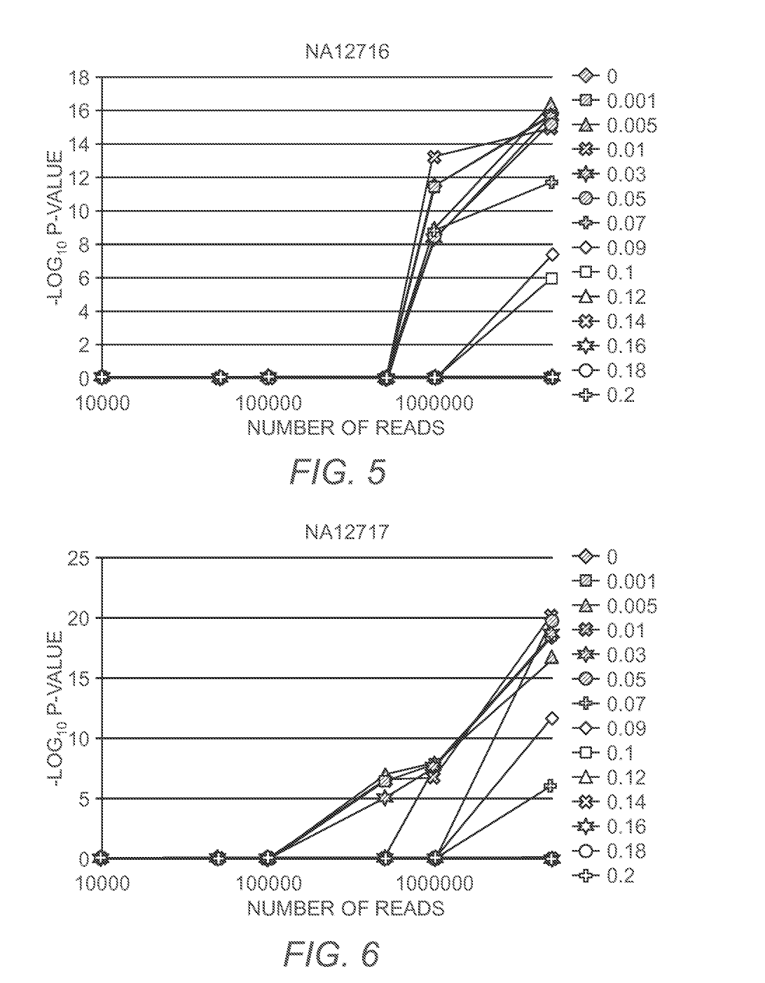

This individual is a male from the CEU population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 1,000,000 reads at error rates of 0%, 0.1%, and 1% (FIG. 5). At a depth of 5,000,000 reads, the individual was correctly identified with up to 7% error (FIG. 5).

### Example 10

### NA12717

This individual is a female from the CEU population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 5,000,000 reads at an error rate of up to 9% (FIG. 6).

### Example 11

### NA12750

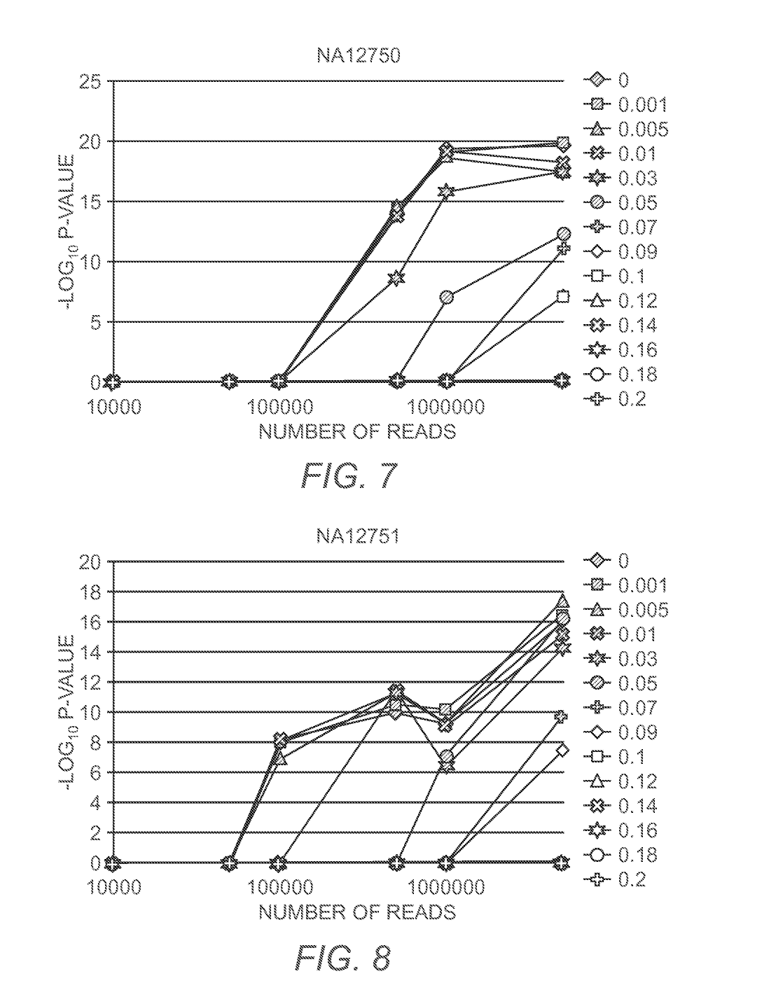

This individual is a male from the CEU population. 10,000, 50,000, 100,000, 500,000, 1,000,000, and 5,000,000 random 51-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 1% (FIG. 7). At a depth of 5,000,000 reads, the individual was correctly identified with up to 7% error (FIG. 7).

### Example 12

### NA12751

This individual is a female from the CEU population. 10,000, 50,000, 300,000, 500,000, 1,000,000, and 5,000,000 random 51-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 3% (FIG. 8). At a depth of 1,000,000 reads, the individual was correctly identified for error rates up to 1%, and at a depth of 5,000,000 reads, the individual was correctly identified with up to 7% error (FIG. 8).

### Example 13

### NA12761

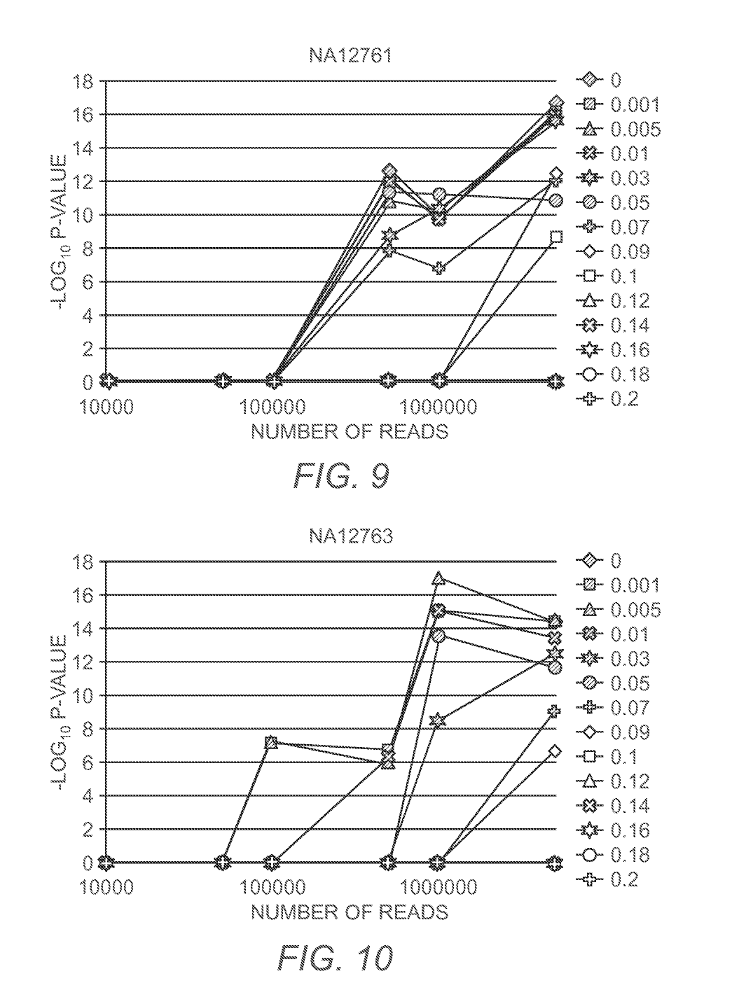

This individual is a female from the CEU population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an Error rate of up to 5% (except at 3%) (FIG. 9). At a depth of 1,000,000 reads, the individual was correctly identified for error rates up to 5%, and at a depth of 5,000,000 reads, the individual was correctly identified with up to 9% error (FIG. 9).

### Example 14

### NA12763

This individual is a female from the CEU population. 10,000, 50,000, 100,000, 500,000, 1,000,000, and 5,000,000 random reads were sampled from the original sequencing file and the sequencing reads were truncated to 50 bp. For each sampling, sequencing errors were artificially added at Frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 1,000,000 reads at error rates up to 5% (except 3%), and at a depth of 5,000,000 reads, the individual was correctly identified with up to 5% error (FIG. 10).

### Example 15

### NA18511

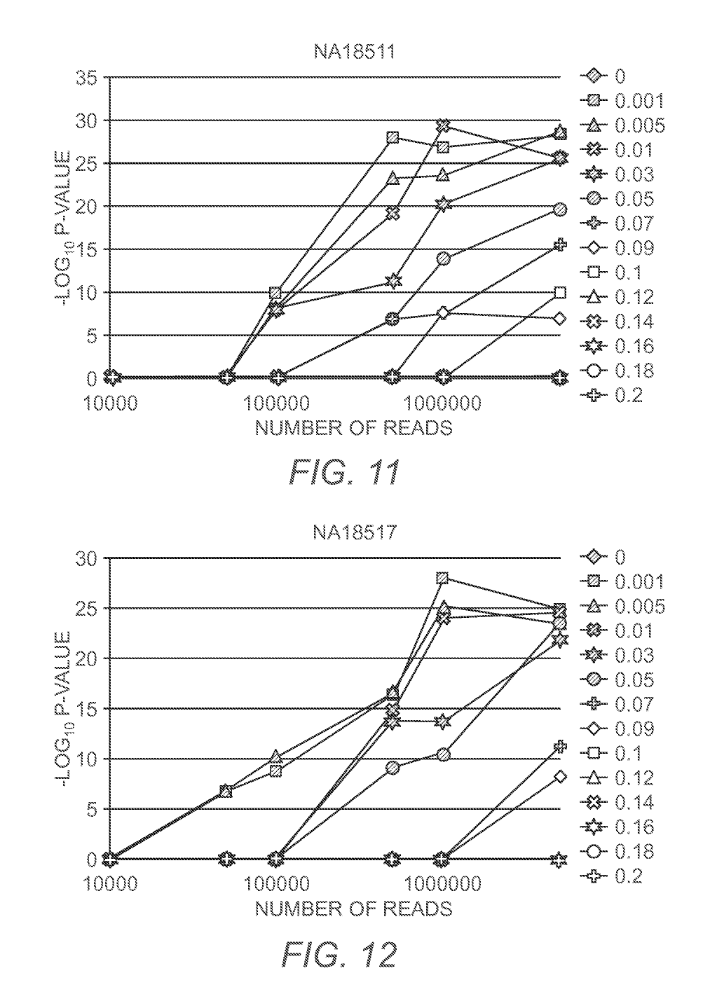

This individual is a female from the YRI (Yoruba in Ibadan, Nigeria) population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 100,000 reads at an error rate of up to 0.1% (FIG. 11). At a depth of 500,000 reads, the individual was identified correctly for error rates up to 3%, and at a depth of 1,000,000 reads, the individual was correctly identified with up to 5% error (FIG. 11). At a depth of 5,000,000 reads, we correctly identified the individual with up to 10% error (except for 9%) (FIG. 11).

### Example 16

### NA18517

This individual is a female from the YRI population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 100,000 reads at an error rate of 0.5% (FIG. 12). At depths of 500,000 and 1,000,000 reads, the individual was correctly identified for error rates up to 5%, and at a depth of 5,000,000 reads, the individual was correctly identified with up to 7% error (FIG. 12).

### Example 17

### NA18523

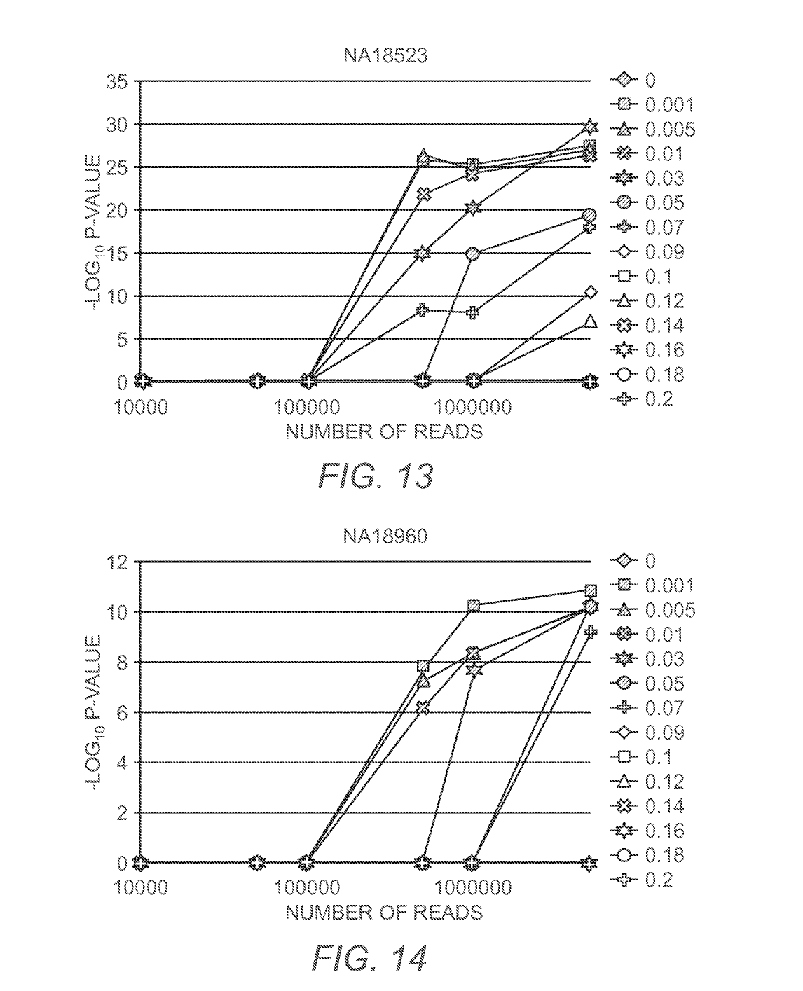

This individual is a female from the YRI population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 3% (FIG. 13). At a depth of 1,000,000 reads, the individual was correctly identified for error rates up to 5%, and at a depth of 5,000,000 reads, the individual was correctly identified with up to 9% error (FIG. 13).

### Example 18

### NA18960

This individual is a male from the JPT (Japanese in Tokyo, Japan) population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 1,000,000 reads at an error rate of up to 0.1% (FIG. 14). At a depth of 5,000,000 reads, the individual was correctly identified with up to 7% error (FIG. 14).

### Example 19

### NA18961

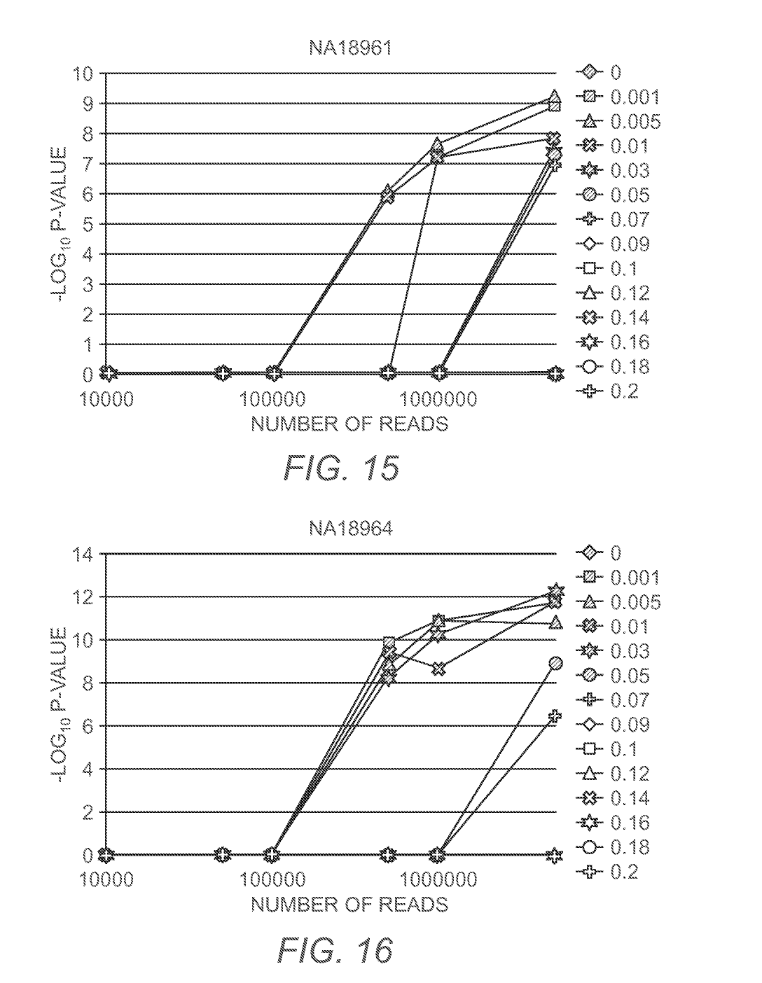

This individual is a male from the CEU population. 10,000, 50,000, 100,000, 500,000, 1,000,000, and 5,000,000 random reads were sampled from the original sequencing file and the sequencing reeds were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 5,000,000 reads and a 0.5% error rate (FIG. 15).

### Example 20

### NA18964

This individual is a female from the JPT population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies or 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference arid a p-value was calculated representing the likelihood that the correct identity was obtained. The correct identity was obtained significantly (p<1×10⁻⁹) at a sequencing depth of 500,000 reads at an error rate of 0%, 0.1%, and 1% (FIG. 16). At a depth of 1,000,000 reads, the individual was correctly identified for error rates up to 3% (except 1%), and at a depth of 5,000,000 reads, the individual was correctly identified with up to 3% error (FIG. 16).

### Example 21

### NA19098

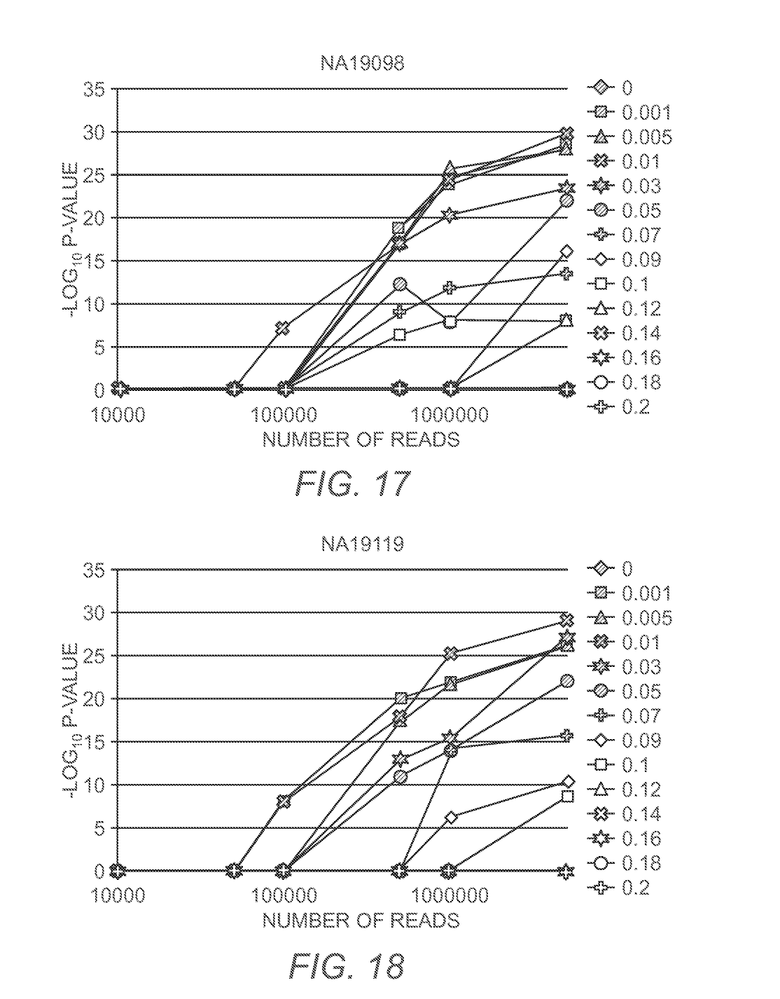

This individual is a male from the YRI population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 5% (FIG. 17). At a depth of 1,000,000 reads, the individual was correctly identified for error rates up to 7% (except for 5%), and at a depth of 5,000,000 reads, the individual was correctly identified with up to 9% error (FIG. 17).

### Example 22

### NA19119

This individual is a male from the YRI population. 10,000, 50,000, 100,000, 500,000, 1,000,000, and 5,000,000 random reads were sampled from the original sequencing file and the sequencing reads were truncated to 50 bp. For each sampling, sequencing errors were artificially added at frequencies of 0.1%, 0.5%, 1%, 3%, 5%, 7%, 9%, 10%, 12%, 14%, 16%, 18%, and 20% of nucleotides For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 5% (FIG. 18). At a depth of 1,000,000 reads, the individual was correctly identified for error rates up to 7%, and at a depth of 5,000,000 reads, the individual was correctly identified with up to 9% error (FIG. 18).

### Example 23

### NA19131

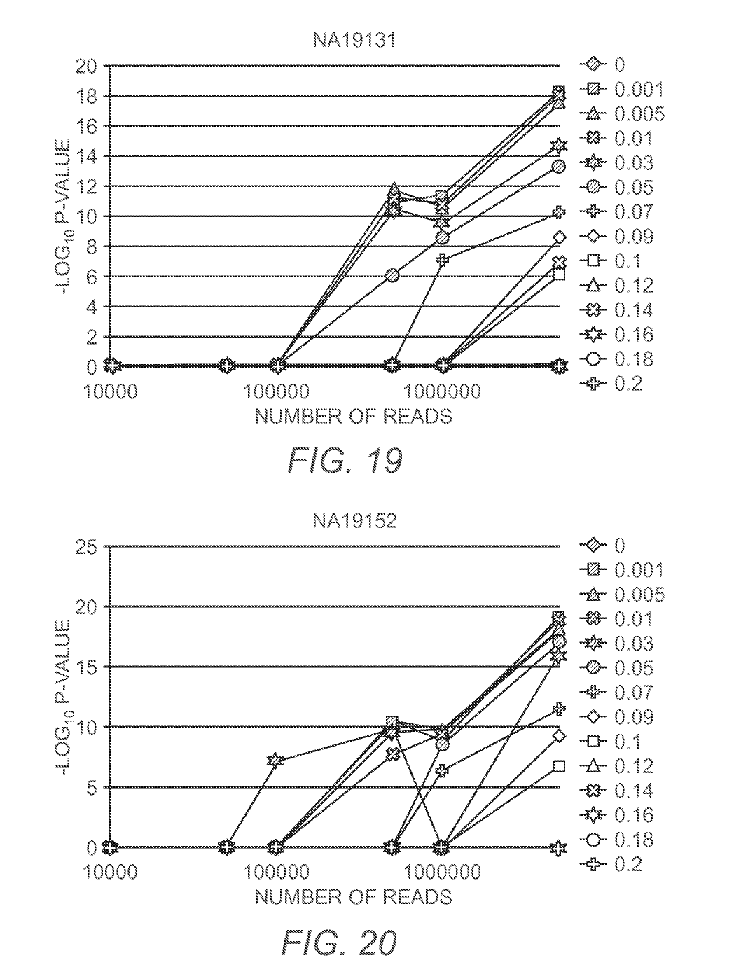

This individual is a female from the YRI population 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 or 1,000,000 reads at an error rate of up to 3% (FIG. 19). At a depth of 5,000,000 reads, the individual was correctly identified with up to 7% error (FIG. 19).

### Example 24

### NA19152

This individual is a female from the YRI population. 10,000, 50,000, 100,000, 500,000, 1,000,000, and 5,000,000 random 36-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity significantly (p<1×10⁻⁹) at a sequencing depth of 500,000 reads at an error rate of up to 3% (except for 1%) (FIG. 20). At a depth of 1,000,000 reads, the individual was correctly identified for error rates up to 1% (except for 0.1%), and at a depth of 5,000,000 reads, life individual was correctly identified with up to 9% error (FIG. 20).

### Example 25

### NA19160

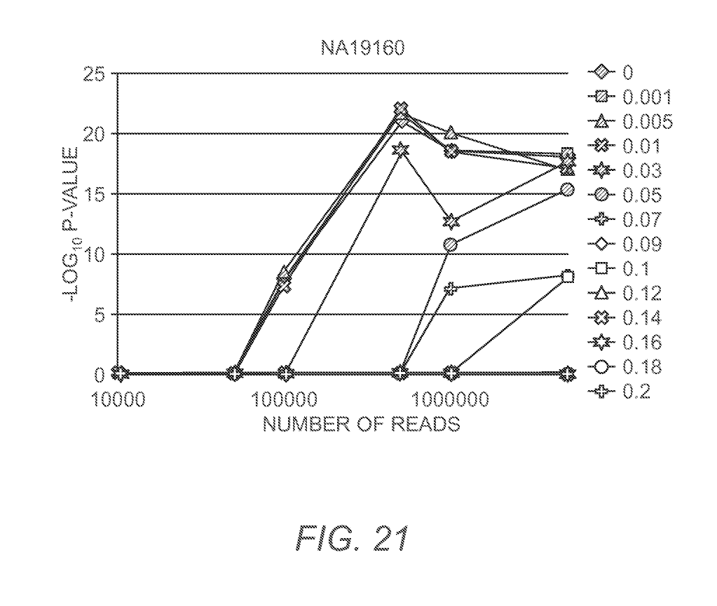

This individual is a male from the YRI population. 10,000, 50,000, 100,000, 500,000, 1,000,000, and 5,000,000 random 51-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads at an error rate of up to 3% (FIG. 21). At a depth of 1,000,000 or 5,000,000 reads, the individual was correctly identified for error rates up to 5% (FIG. 21).

### Example 26

### NA18959

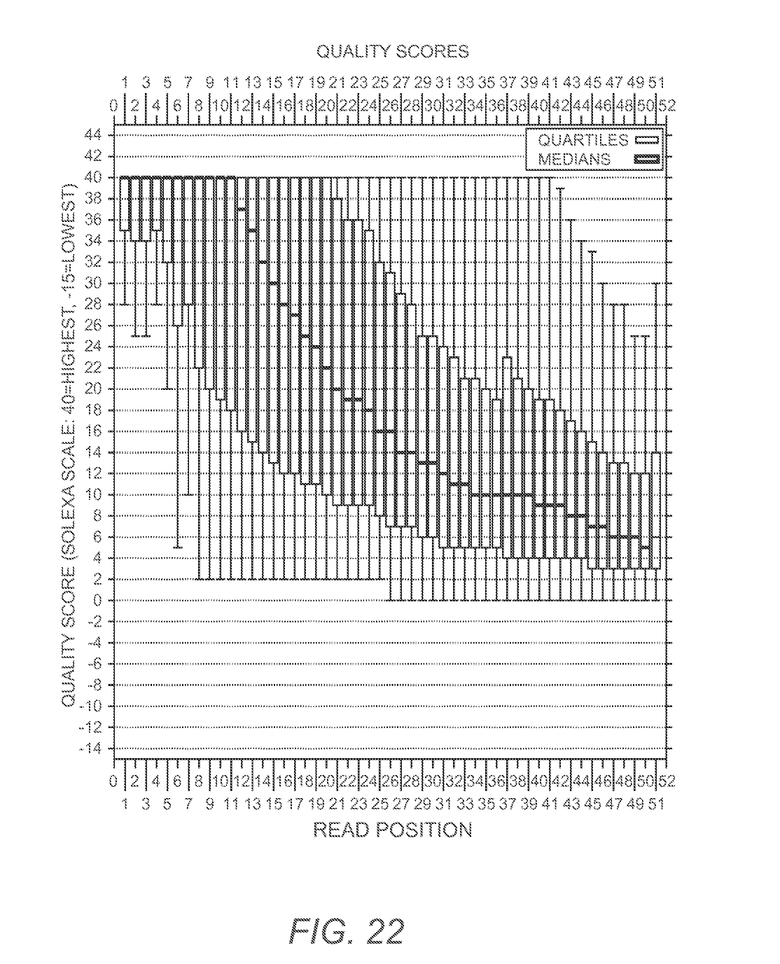

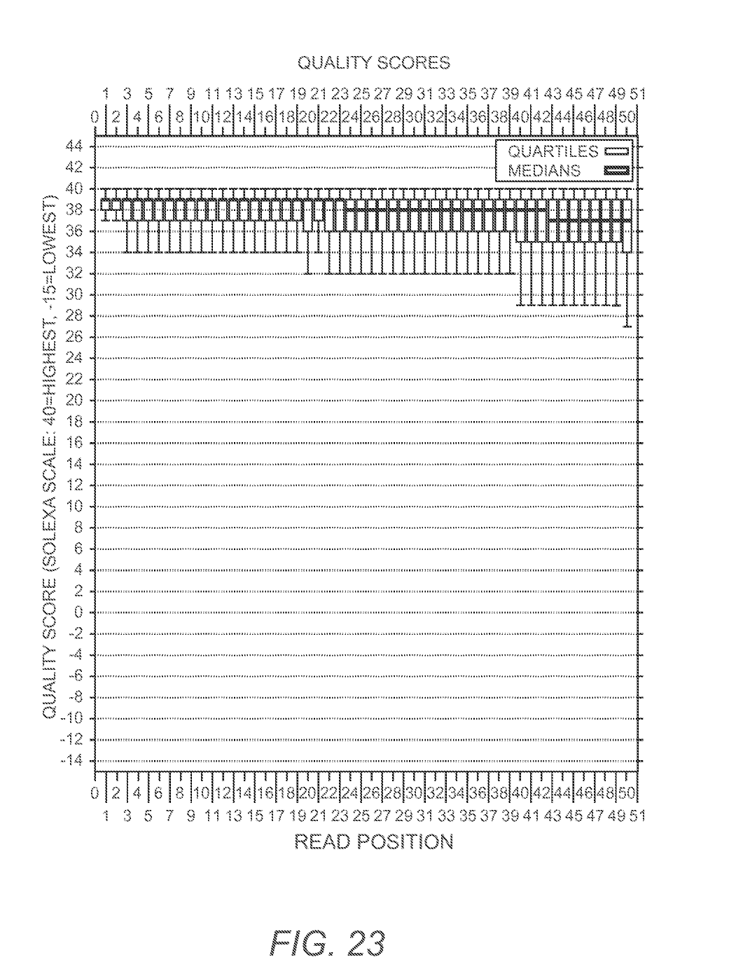

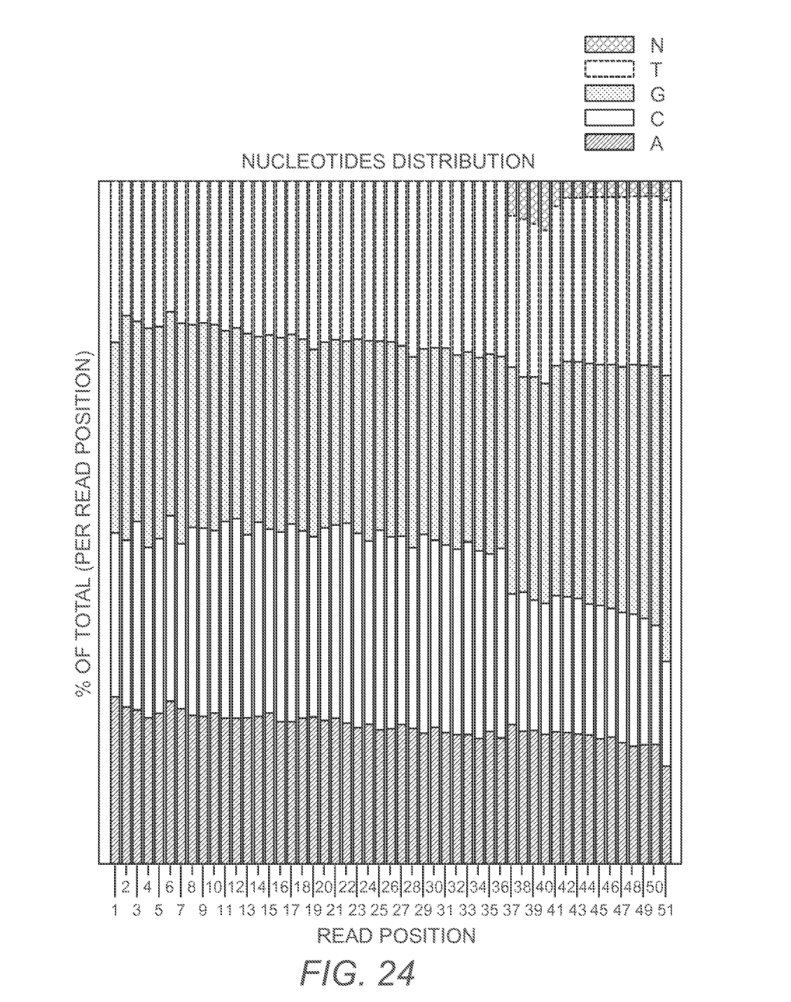

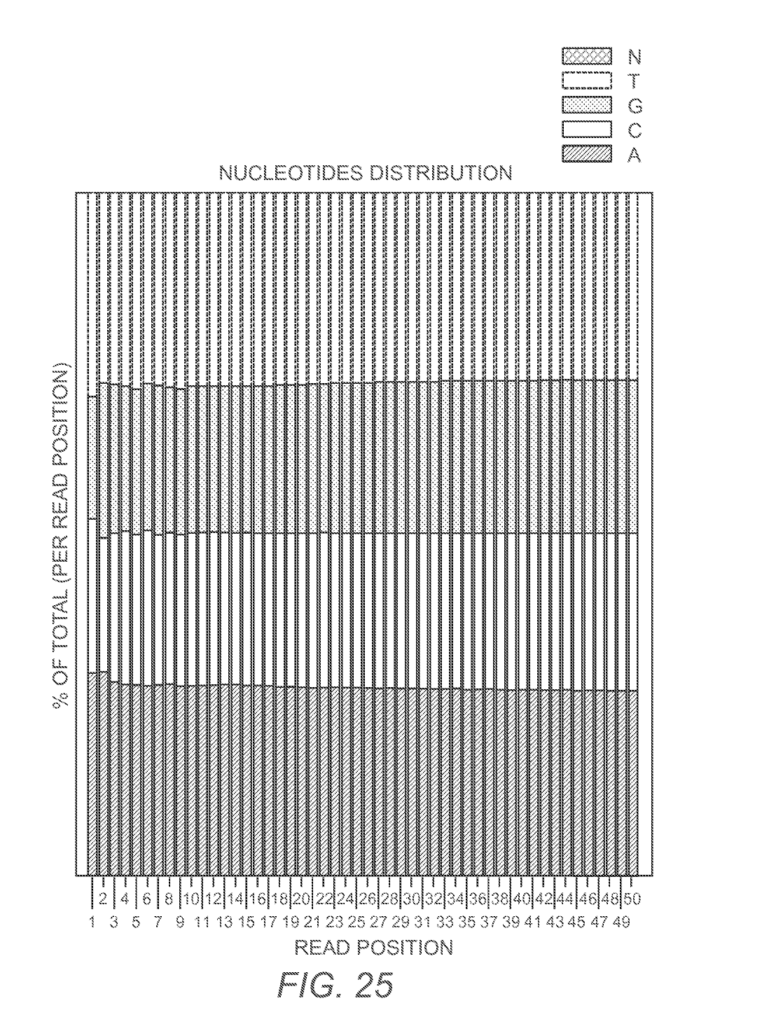

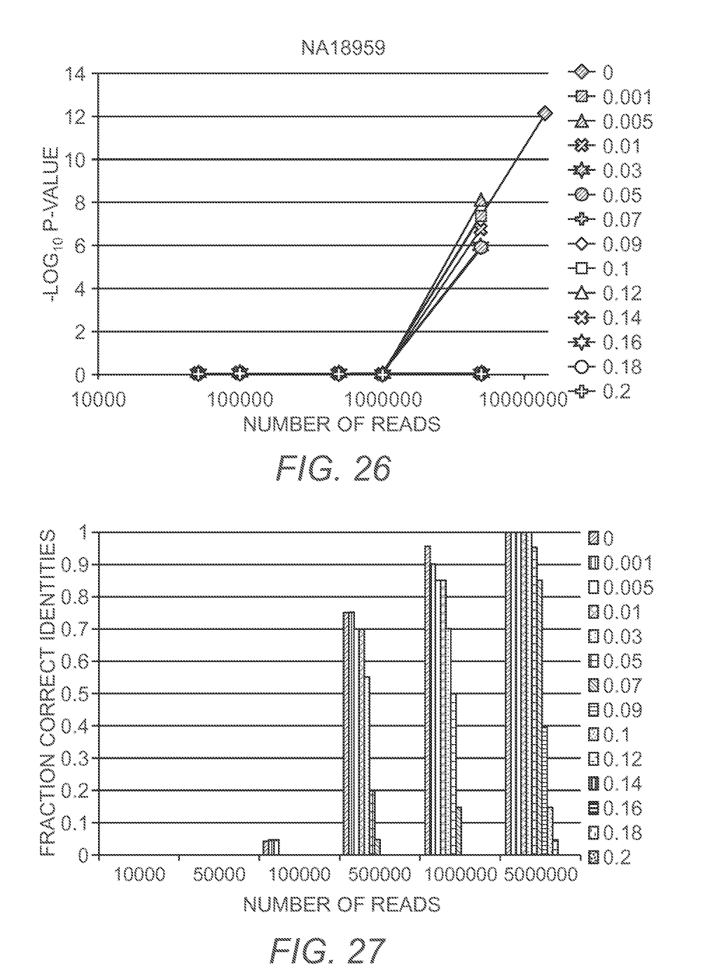

This individual is a male from the JPT population. 10,000, 50,000, 100,000, 500,000, 1,000,000, and 5,000,000 random 51-bp reads were sampled from the original sequencing file. For each sampling, sequencing errors were artificially added at frequencies of 0.1%, 0.5%, 1%, 3%, 5%, 7%, 9%, 10%, 12%, 14%, 16%, 18%, and 20% of nucleotides. For each sampling and for each error rate, the sequencing reads were aligned to the synthetic reference and a p-value was calculated representing the likelihood that the correct identity was obtained. The sequencing reads obtained for this individual had a much higher inherent error rate and overall very poor quality. To demonstrate these issues, the distribution of base call quality scores along every position in the read were computed for this individual (FIG. 22) and NA18511 (FIG. 23), a high-quality sample. Also, the base call frequencies along every position in the read were computed for this individual (FIG. 24) and NA18511 (FIG. 25). The precipitous drop in base call qualities (depicted as boxplots) and simultaneously high variation and high GC bias in the base calls themselves likely explain why a correct identity for this individual was not obtained for any number of reads up to 5,000,000 (FIG. 26). However, when using all reads available from this file (14,084,246 reads), we obtained the correct identity significantly (p=7.28×10⁻¹³), indicating that the methods used were robust enough to overcome very poor sequencing quality given sufficient depth.

### Example 27

### Substitution Error Summary

The data presented above for individuals NA07051, NA12717, NA12750, NA12751, NA12761, NA19098, NA19131, NA19152, NA19160, NA07037, NA12249, NA12763, NA18511, NA18517, NA18523, NA18960, NA18964, NA19119, NA10847, and NA12716 were summarized to demonstrate the frequency at which the methods used determined an identity successfully for each given read depth and error rate (FIG. 27). At 100,000 reads, 1 out of the 20 individuals was correctly identified at up to 0.5% error. At 500,000 reads, at least 14 of the 20 individuals were correctly identified at up to 1% error. At 1,000,000 reads, at least 14 of the 20 individuals were correctly identified at up to 3% error. At 5,000,000 reads, all 20 individuals were correctly identified at up to 3% error, and 17 of 20 individuals were correctly identified at up to 7% error. One individual was correctly identified at an error rate of 12% with 5,000,000 reads.

### Example 28

### Insertion Errors

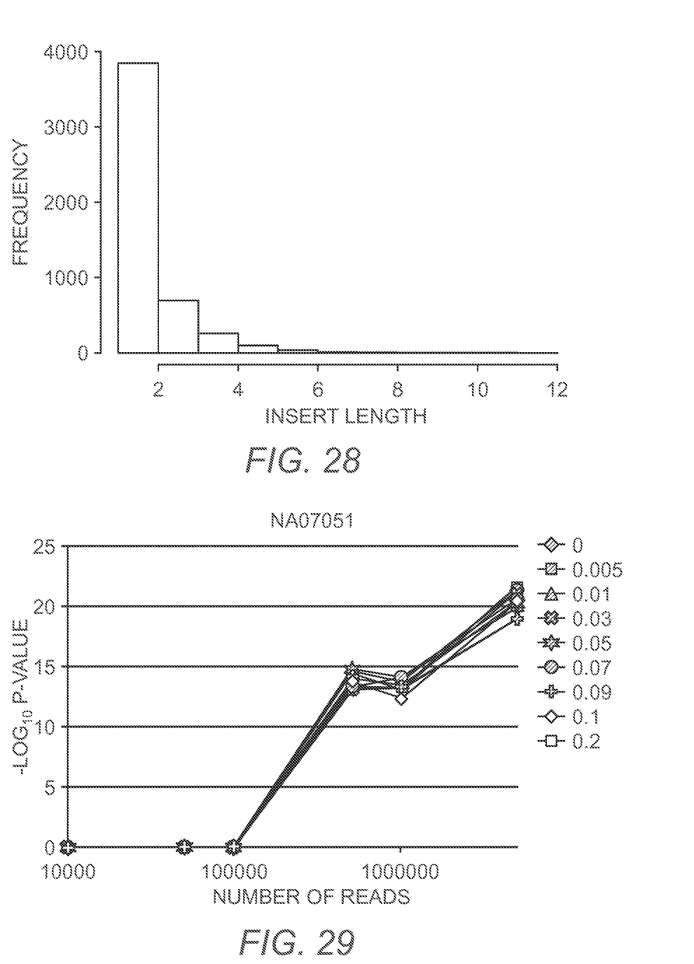

For each sampling of reads as described above, the effect of insertion errors in the sequencing was also tested. Since most sequencing insertion errors are short (mainly 1-2 bp), random nucleotides were inserted into the read sampling files at lengths that follow the exponential distribution. An example of the insertion lengths for individual NA18511 is depicted as a histogram (FIG. 28). Those additional random nucleotides were inserted at random positions of the sampled reads at frequencies of 0.5%, 1%, 3%, 5%, 7%, 9%, 10%, and 20% of reads. Examples 29-41 show the ability to obtain correct identities in the presence of these insertion errors, and examples 42-52 for a combination of a 3% substitution error rate and insertion errors at varying frequencies.

### Example 29

### NA07051

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of at least 500,000 reads, the individual was correctly identified for all tested additional error rates (FIG. 29).

### Example 30

### NA10847

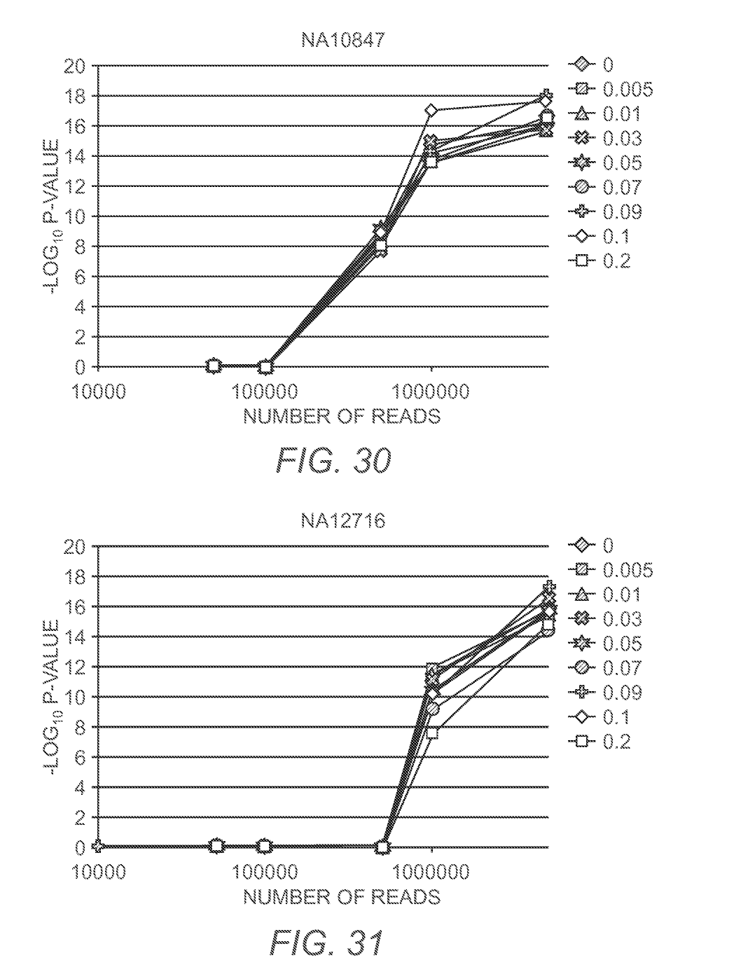

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of at least 1,000,000 reads, the individual was correctly identified for all tested additional error rates (FIG. 30).

### Example 31

### NA12716

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 1,000,000 reads, the individual was correctly identified for additional error rates of up to 10% of reads, and was correctly identified for all tested additional error rates at a depth of 5,000,000 reads (FIG. 31).

### Example 32

### NA12717

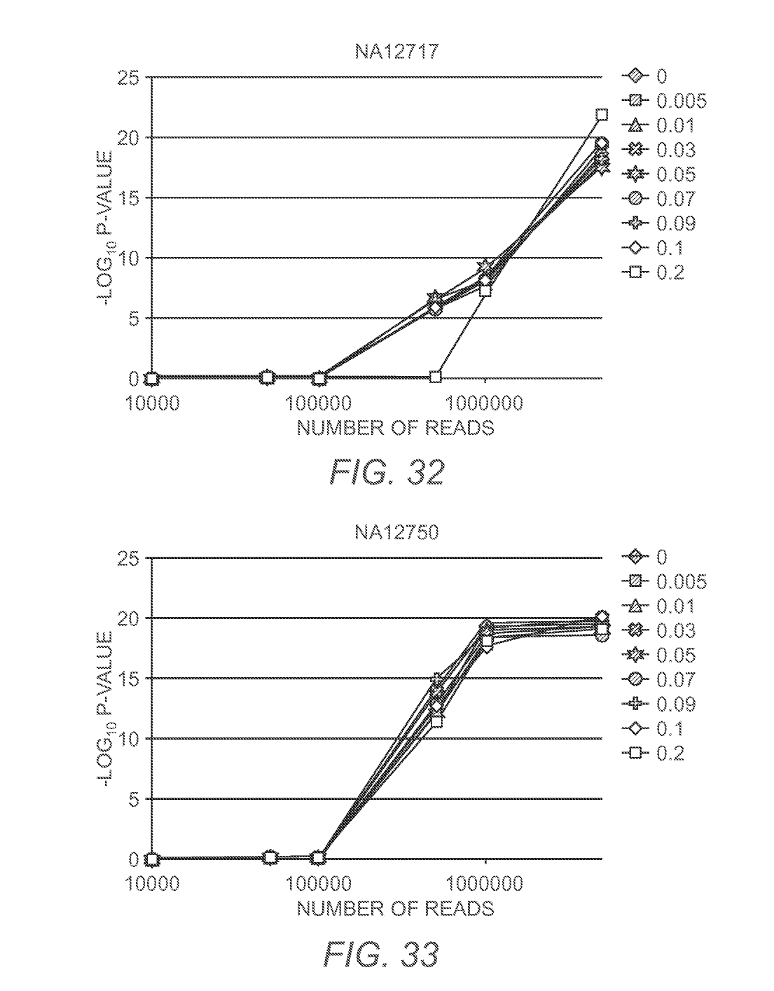

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 5,000,000 reads, the individual was correctly identified tor all tested additional error rates (FIG. 32).

### Example 33

### NA12750

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood dial the correct identity was obtained. At a depth of at least 500,000 reads, the individual was correctly identified for all tested additional error rates (FIG. 33).

### Example 34

### NA12751

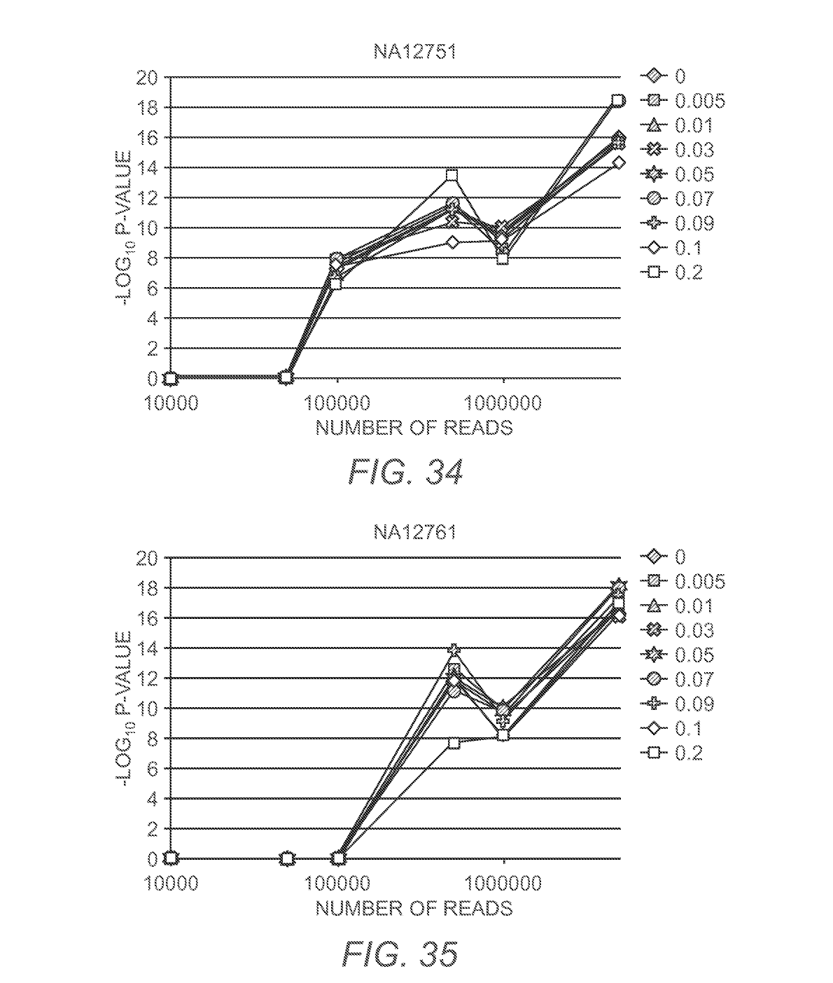

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 500,000 reads, the individual was correctly identified for all tested additional error rates (FIG. 34). At a depth of 1,000,000 reads, a correct identity was obtained for all tested additional error rates except 7% and 20% of reads, but at a depth of 5,000,000 reads, the individual was correctly identified for ail additional error rates tested (FIG. 34).

### Example 35

### NA12761

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. Tor each sampling and for each error rate, the sequencing reads were aligned to the synthetic reference and a p-value was calculated representing the likelihood that the correct identity was obtained. At a depth of 500,000 reads, the individual was correctly identified tor an additional error rate of up to 10% of reads (FIG. 35). At a depth of 1,000,000 reads, the individual was correctly identified for an additional error rate of up to 9% of reads, and at 5,000,000 reads, a correct identity was obtained for all tested additional error rates (FIG. 35).

### Example 36

### NA19098

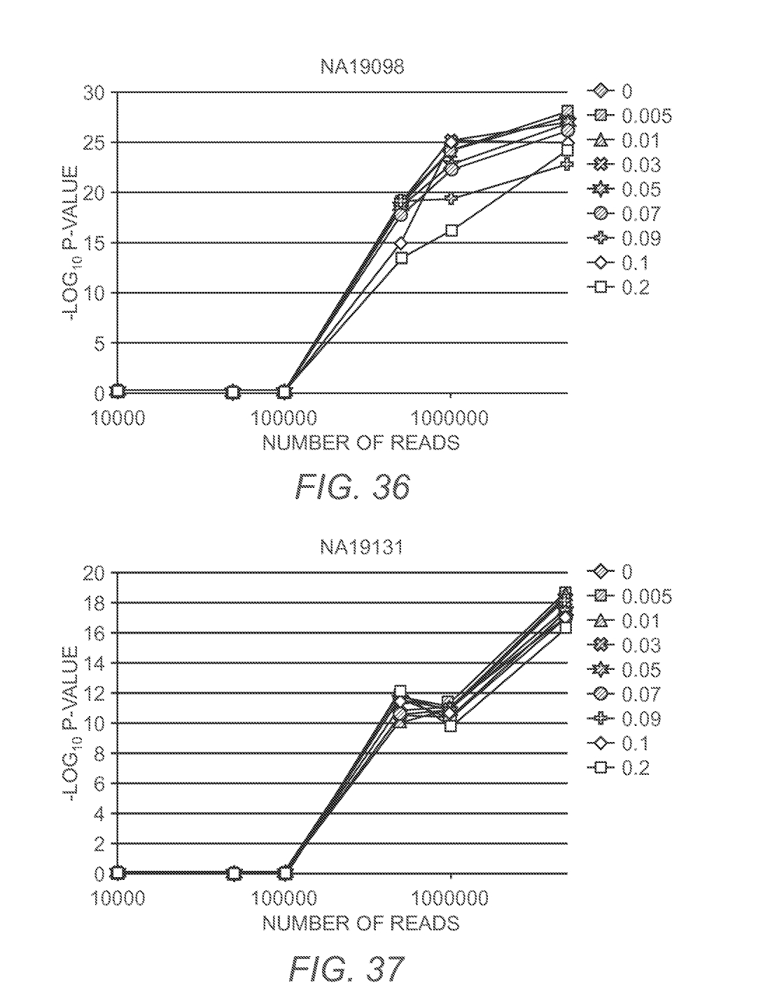

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of at least 500,000 reads, the individual was correctly identified for all tested additional error rates (FIG. 36).

### Example 37

### NA19131

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of at least 500,000 reads, the individual was correctly identified for all tested additional error rates (FIG. 37).

### Example 38

### NA19152

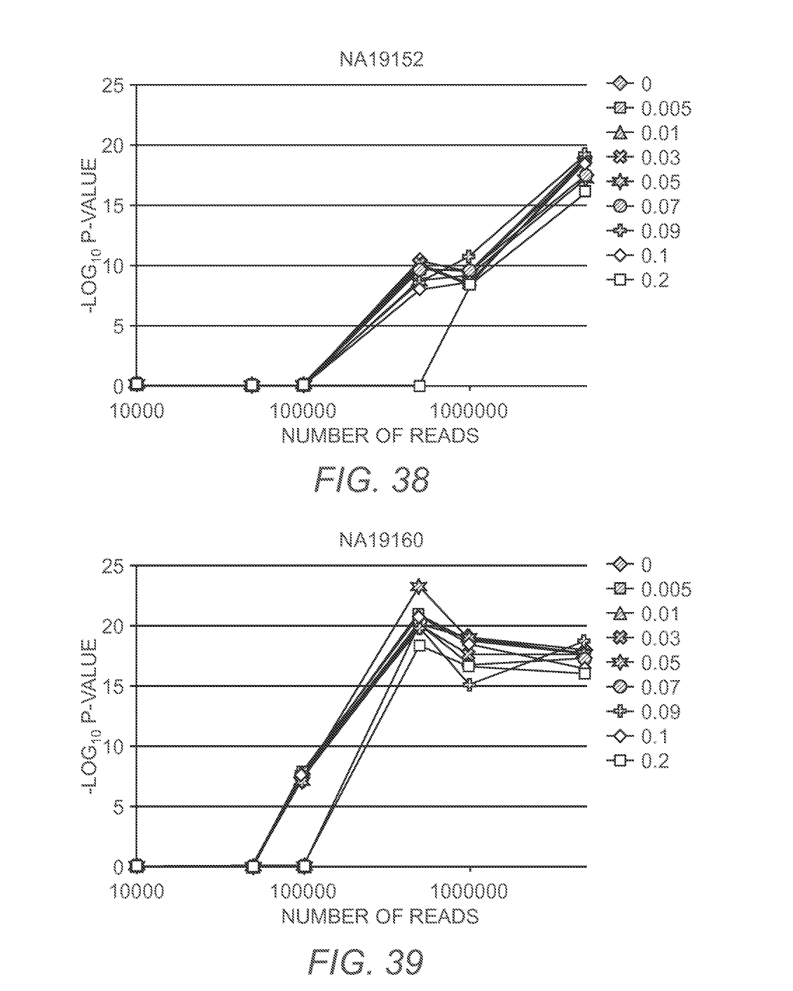

The reads obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 500,000 reads, the individual was correctly identified for an additional error rate of up to 7% of reads (except 5%) (FIG. 38). At a depth of 1,000,000 reads, the individual was correctly identified for an additional error rate of up to 9% of reads (except 3%), and at 5,000,000 reads, was correctly identified for all tested additional error rates (FIG. 38).

### Example 39

### NA19160

The data obtained for this individual (outlined above) were modified to include insertion errors at a frequency of 0.5-20% of reads. For each sampling, additional random nucleotides were inserted at random positions of the sampled reads at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of at least 500,000 reads, the individual was correctly identified for all tested additional error rates (FIG. 39).

### Example 40

### Insertion Error Summary

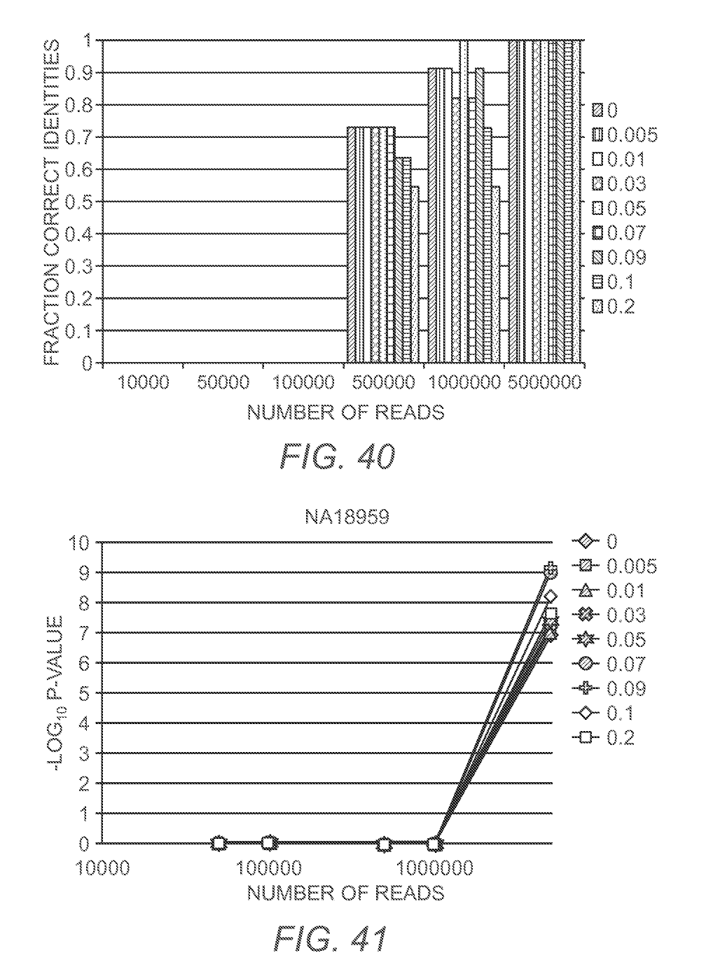

The data presented above for individuals NA07051, NA10847, NA12716, NA12717, NA12750, NA12751, NA12761, NA19098, NA19131, NA19152, and NA19160 were summarized to demonstrate the frequency at which the applied methods determined an identity successfully for each given read depth and insertion error rate (FIG. 40). At 500,000 reads, 8 of the 11 individuals were correctly identified at an error tale of up to 7% of reads. At 1,000,000 reads, at least 8 of the 11 individuals were correctly identified at an error rate of up to 10% of reads. At 5,000,000 reads, all II individuals were correctly identified at all additional error rates tested.

### Example 41

### NA18959

The reads obtained for this individual had a very high inherent sequencing error rate, as described above. Despite their poor quality, this individual was correctly identified at a depth of 5,000,000 for two of the additional error rates (7 and 9% of reads), however, the rest of those tested were of borderline significance, indicating that similar to the substitution errors above, a slightly higher read depth would completely overcome the high inherent error rate leading to accurate identification (FIG. 41).

### Example 42

### NA37051 Combination Errors

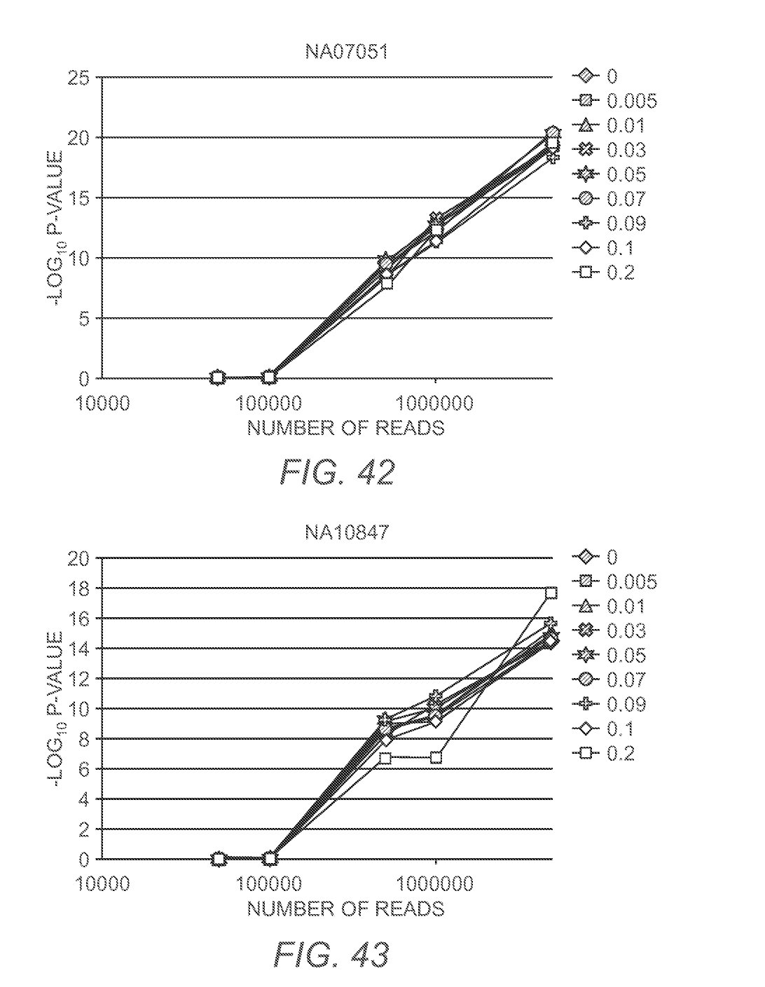

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 500,000 reads, this individual was correctly identified for an insertion error rate of up to 7% of reads (except 3%), and at a depth of at least 1,000,000 reads, this individual was correctly identified for all additional error rates tested (FIG. 42).

### Example 43

### NA10847 Combination Errors

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 1,000,000 reads, this individual was correctly identified for an insertion error rate of up to 10% of reads, and at a depth of 5,000,000 reads, was correctly identified for all additional error rates tested (FIG. 43).

### Example 44

### NA12716 Combination Errors

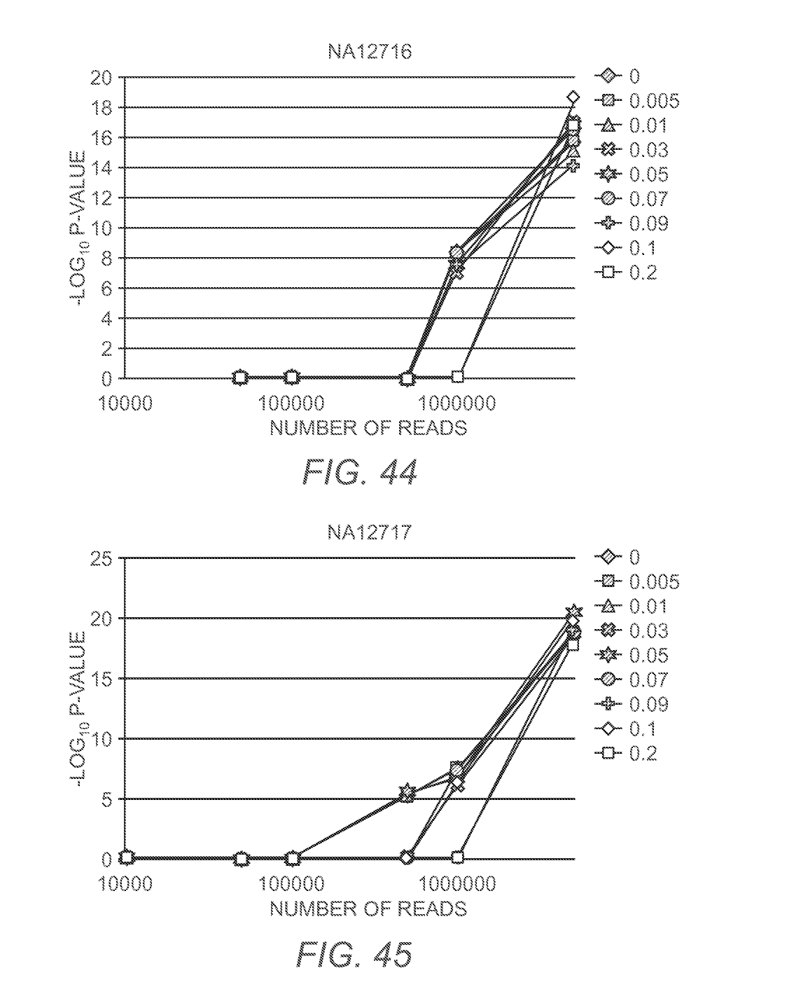

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 5,000,000 reads, this individual was correctly identified for all additional error rates tested (FIG. 44).

### Example 45

### NA12717 Combination Errors

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 5,000,000 reads, this individual was correctly identified for all additional error rates tested (FIG. 45).

### Example 46

### NA12750 Combination Errors

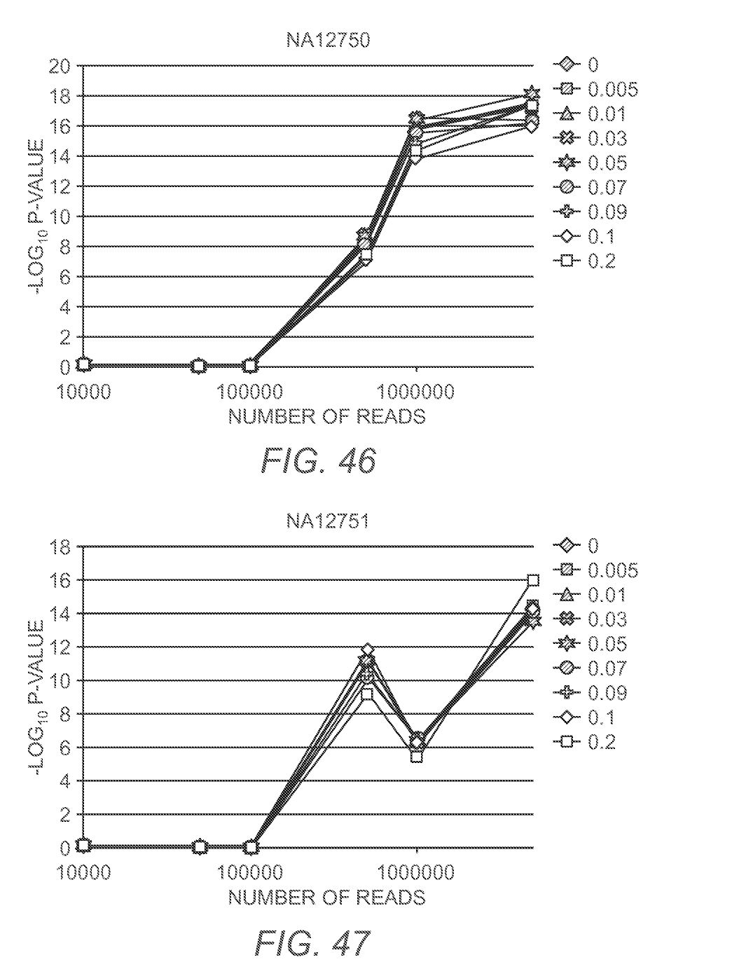

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood dial the correct identity was obtained. At a depth of at least 1,000,000 reads, this individual was correctly identified for all additional error rates tested (FIG. 46).

### Example 47

### NA12751 Combination Errors

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At depths of 500,000 and 5,00,000 reads, this individual was correctly identified for all additional error rates tested (FIG. 47).

### Example 48

### NA12761 Combination Errors

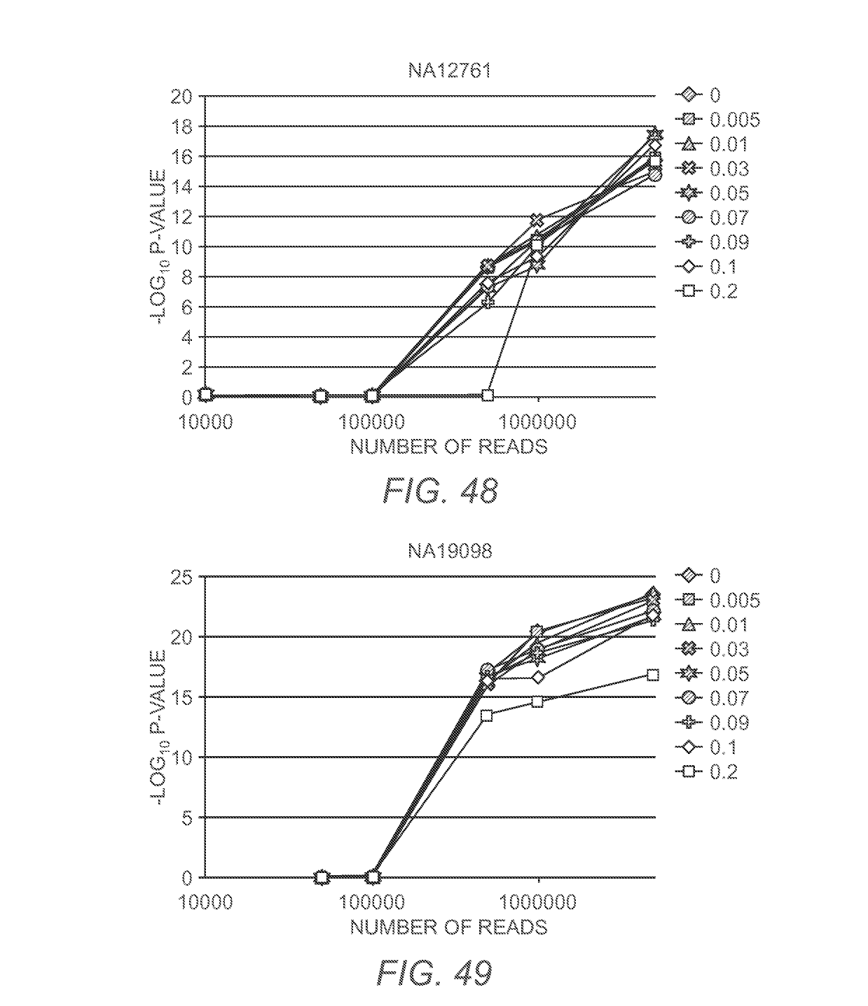

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 1,000,000 reads, this individual was correctly identified for all additional error rates tested except 5%, and at a depth of 5,000,000 reads, was correctly identified for all additional error rates tested (FIG. 48).

### Example 49

### NA19098 Combination Errors

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 500,000 reads, this individual was correctly identified for all additional error rates tested (FIG. 49).

### Example 50

### NA19131 Combination Errors

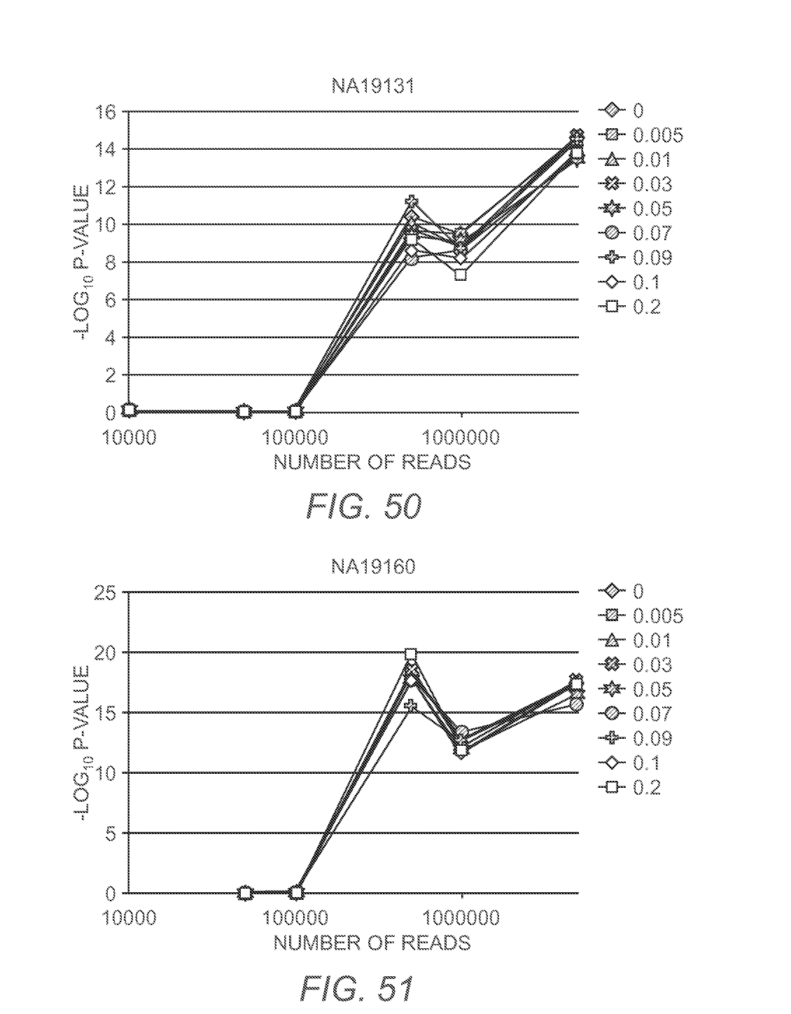

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing the likelihood that the correct identity was obtained. At a depth of 500,000 reads, this individual was correctly identified for all additional error rates tested except 7% and 10% (FIG. 50). At a depth of 5,000,000 reads, this individual was correctly identified for all additional error rates tested (FIG. 50).

### Example 51

### NA19160 Combination Errors

The reads obtained for this individual (outlined above) were modified to include substitution errors at a rate of 3% of bases as well as insertion errors at frequencies of 0.5%, 1%, 3%, 5%, 7%, 9%, 10%, and 20% of reads. For each sampling and for each error rate, the sequencing reads were aligned to the synthetic reference and a p-value was calculated representing (be likelihood that the correct identity was obtained. At a depth of 500,000 reads, this individual was correctly identified for all additional error rates tested (FIG. 51).

### Example 52

### Combination Error Summary

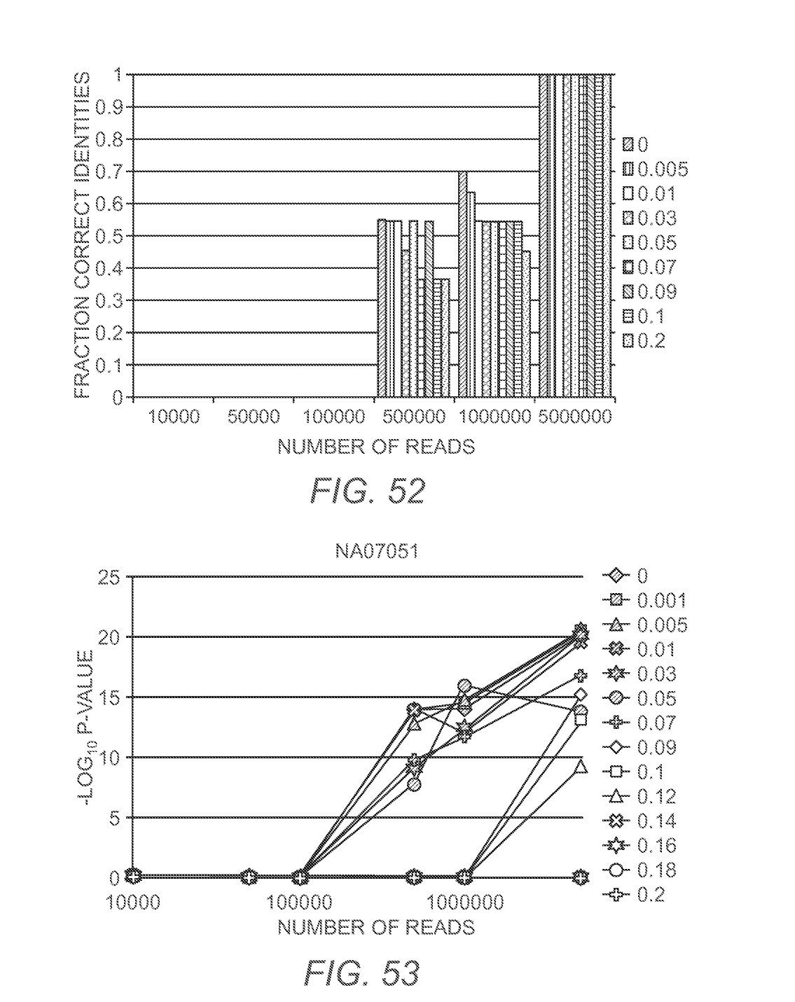

The data presented above for individuals NA07051, NA10847, NA12716, NA12717, NA12750, NA12751, NA12761, NA19098, NA19131, and NA19160 were summarized to demonstrate the frequency at which the methods used determined an identity successfully for each given read depth and insertion error rate in conjunction with a 3% substitution error rate (FIG. 52). At 500,000 reads, 5 of the 10 individuals were correctly identified at most insertion error rates up to 9% of reads. At 1,000,000 reads, at least 6 of the 10 individuals were correctly identified at an insertion error rate of up to 10% of reads. At 5,000,000 reads, all 10 individuals were correctly identified at all additional error rates tested.

### Example 53

### NA07051

The reads obtained for this individual (outlined above) were modified to include additional substitution errors (exactly as described in Example 6), however the reads were aligned to the allele index where indels were permitted to be a length of 2 bases or greater. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads for up to 7% error (except 5%) (FIG. 53). At a depth of 1,000,000 reads, this individual was correctly identified for error rates up to 7%, and at a depth of 5,000,000 reads, the individual was correctly identified with up to 12% error (FIG. 53).

### Example 54

### NA12761

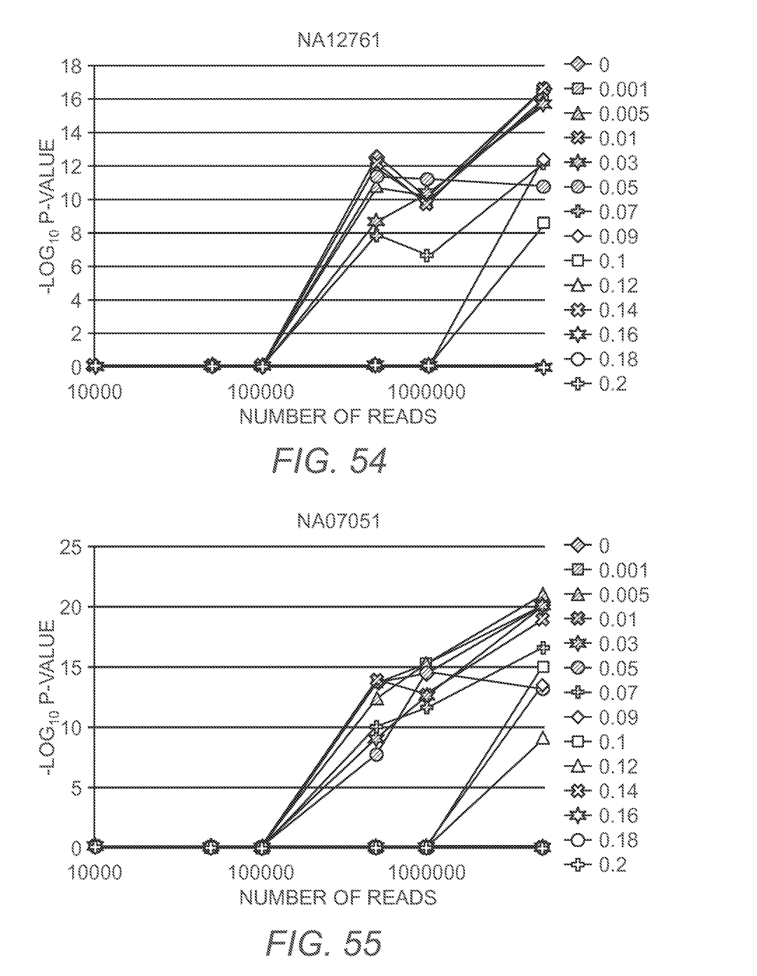

The reads obtained for this individual (outlined above) were modified to include additional substitution errors (exactly as described in Example 13), however the reads were aligned to the allele index where indels were permitted to be a length of 2 bases or greater. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads for up to 5% error (except 3%) (FIG. 54). At a depth of 1,000,000 reads, this individual was correctly identified for error rates up to 5%, and at a depth of 5,000,000 reads, the individual was correctly identified with up to 9% error (FIG. 54).

### Example 55

### NA07051

The reads obtained for this individual (outlined above) were modified to include additional substitution errors (exactly as described in Example 6), however the reads were aligned to the allele index where indels were permitted to be a length of 1 base or greater. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads for up to 7% error (except 5%) (FIG. 55). At a depth of 1,000,000 reads, this individual was correctly identified for error rates up to 7%, and at a depth of 5,000,000 reads, the individual was correctly identified with up to 12% error (FIG. 55).

### Example 56

### NA12761

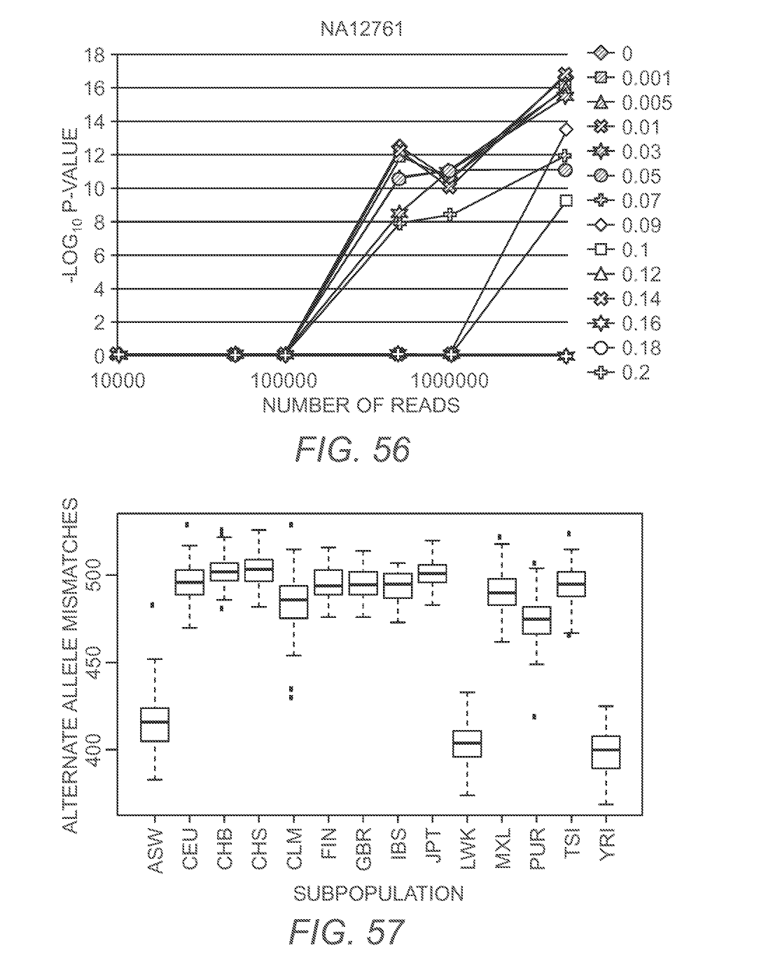

The reads obtained for this individual (outlined above) were modified to include additional substitution errors (exactly as described in Example 13), however the reads were aligned to the allele index where indels were permitted to be a length of 1 base or greater. For each sampling and for each error rate, the sequencing reads were aligned to the synthetic reference and a p-value was calculated representing the likelihood that the correct identity was obtained. The correct identity was obtained significantly (p<1×10⁻⁹) at a sequencing depth of 500,000 reads for up to 5% error (except 3%) (FIG. 56). At a depth of 1,000,000 reads, this individual was correctly identified for error rates up to 5%, and at a depth of 5,000,000 reads, the individual was correctly identified with up to 10% error (FIG. 56).

### Example 57

### Determination of Subpopulation for NA18511

This individual is a female from the YRI (Yoruba in Ibadan, Nigeria) population. 5,000,000 random reads were sampled from the original sequencing file and the sequencing reads were truncated to 50 bp. As above in Example 15, sequencing errors were artificially added to a frequency of 0.1% of nucleotides, and these sequencing reads were aligned to the synthetic reference as described in example 15. The number of reads mapping to inconsistent alternate alleles were identified and summed, generating an independent sum for each of the 1092 individuals in the data set. The individual NA18511 was removed from this set. of sums to simulate a case when the individual is not in the reference allele database. Individuals for whom subpopulation assignment was not available from the 1000 Genomes Project were also removed. Individuals were then assigned to their subpopulations, and the subpopulation distributions of alternate allele inconsistencies were plotted in a box plot (FIG. 57).

The abbreviations refer to the subpopulations as annotated by 1000 Genomes Project, which appear below:
ASW HapMap African ancestry individuals from SW US
CEU CEPH individuals
CHB (CHB) Han Chinese in Beijing
CHS (CHB) Han Chinese South
CLM Colombian in Medellin, Colombia
FIN HapMap Finnish individuals from Finland
GBR British individuals from England and Scotland (GBR)
IBS Iberian populations in Spain
JPT JPT Japanese individuals
LWK (LWK) Luhya individuals
MXL HapMap Mexican individuals from LA California
PUR Puerto Rican in Puerto Rico
TSI Toscan individuals
YRI (YRI) Yoruba individuals

As the subpopulations are intended to be mutually exclusive, in this case the most likely subpopulation was assigned as that with the least sum of alternate allele inconsistencies, in this case YRI. This is the correct assignment for this individual. The mean and standard deviation of summed alternate allele inconsistencies within each population appears below, with the identified subpopulation in bold.

| | Mean | Standard Deviation |
|---|---|---|
| GBR | 496 | 9.1 |
| FIN | 496 | 9.6 |
| CHS | 504 | 9.3 |
| PUR | 474 | 14.3 |
| CLM | 484 | 17.3 |
| IBS | 492 | 11.3 |
| CEU | 496 | 10.4 |
| YRI | 399 | 12.8 |
| CHB | 502 | 9.3 |
| JPT | 501 | 7.9 |
| LWK | 404 | 11.9 |
| ASW | 415 | 16.7 |
| MXL | 491 | 11.4 |
| TSI | 495 | 10.1 |

All publications, patent applications, patents and other references cited herein are incorporated by reference in their entireties for the teachings relevant to the sentence and/or paragraph in which the reference is presented.

The foregoing is illustrative of the present invention, and is not to be construed as limiting thereof. The invention is defined by the following claims, with equivalents of the claims to be included therein.

1-146. (canceled)

147. A system for identifying a person, comprising:
a processor, and
a memory coupled to the processor and comprising computer readable program code embodied in the memory that when executed by the processor causes the processor to perform operations comprising:
aligning nucleic acid sequence data from a query sequence from said person with nucleic acid sequence data from at least one reference sequence; wherein the nucleic acid sequence data from the query sequence has at least a 1% error rate;
identifying a plurality of informative sites in the query sequence from the alignment of nucleic acid sequence data, wherein each informative site corresponds to either an alternate allele or a reference allele for an insertion of at least one base or a deletion of at least one base;
comparing the plurality of informative sites in the query sequence with at least one set of reference informative sites to determine the number of mismatches at informative sites; determining if said person is a match to the at least one set of reference informative sites based on the number of mismatches at the informative sites;
and reporting whether a match is identified.

148. The system of claim 147, wherein the comparing the plurality of informative sites in the query sequence with at least one set of reference informative sites comprises comparing the plurality of informative sites in the query sequence to a reference index of informative sites comprising sets of reference informative sites corresponding to a plurality of individuals, wherein each set of reference informative sites corresponds to one individual.

149. The system of claim 148, wherein the plurality of informative sites in the query sequence contains at least 10 mismatches with at least one set of reference informative sites in the reference index of informative sites.

150. The system of claim 147, wherein the plurality of informative sites in the query sequence comprises at least 400 informative sites.

151. The system of claim 147, wherein the determining if said person is a match to the at least one set of reference informative sites based on the number of mismatches at the informative sites comprises positively identifying an individual with a significance value of 1×10⁻⁹ or smaller.

152. The system of claim 147, wherein the determining if said person is a match to the at least one set of reference informative sites based on the number of mismatches at the informative sites results in an exact match.

153. The system of claim 147, further comprising assigning said person to a subpopulation based upon the best match between the informative sites in the query sequence and the at least one set of reference informative sites.

154. The system of claim 147, wherein the nucleic acid sequence data from the query sequence has at least a 5% error rate.

155. The system of claim 147, wherein the nucleic acid sequence data from the query sequence has at least a 10% error rate.

156. A system for identifying a biological sample, comprising:
a processor; and
a memory coupled to the processor and comprising computer readable program code embodied in tile memory that when executed by the processor causes the processor to perform operations comprising:
aligning nucleic acid sequence data from a query sequence from said biological sample with nucleic acid sequence data from at least one reference sequence; wherein the nucleic acid sequence data from the query sequence has at least a 1% error rate;
identifying a plurality of informative sites in the query sequence from file alignment of nucleic acid sequence data, wherein each informative site corresponds to either an alternate allele or a reference allele for an insertion of at least one base or a deletion of at least one base;
comparing the plurality of informative sites in the query sequence with at least one set of reference informative sites to determine the number of mismatches at informative sites;
determining if said biological sample is a match to the at least one set of reference informative sites based on the number of mismatches at the informative sites; and reporting whether a match is identified.

157. The system of claim 156, wherein the comparing the plurality of informative sites in the query sequence with at least one set of reference informative sites comprises comparing the plurality of informative sites in the query sequence to a reference index of informative sites comprising sets of reference informative sites corresponding to a plurality of different biological samples, wherein each set of reference informative sites corresponds to biological samples.

158. The system of claim 157, wherein the plurality of informative sites in the query sequence contains at least 10 mismatches with at least one set of reference informative sites in the reference index of informative sites.

159. The system of claim 156, wherein the plurality of informative sites in the query sequence comprises at least 400 informative sites.

160. The system of claim 156, wherein the determining if said biological sample is a match to the at least one set of reference informative sites based on the number of mismatches at the informative sites comprises positively identifying biological sample with a significance value of 1×10⁻⁹ or smaller.

161. The system of claim 156, wherein the determining if said biological sample is a match to the at least one set of reference informative sites based on the number of mismatches at the informative sites results in an exact match.

162. The system of claim 156, further comprising assigning said biological sample to a subpopulation based upon the best match between the informative sites in the query sequence and the at least one set of reference informative sites.

163. The system of claim 156, wherein the biological sample comprises biological material from one or more of an animal, plant, bacteria, virus, and fungus.

164. The system of claim 156, wherein the biological sample comprises a mixture of biological materials.

165. The system of claim 156, wherein the nucleic acid sequence data from the query sequence has at least a 10% error rate.

166. The system of claim 156, wherein the nucleic acid sequence data from at least one reference sequence comprises at least one synthetic reference sequence.
